(19) United States
(12) Patent Application Publication
(10) Pub. No.: US 2021/0394660 A1
(43) Pub. Date: Dec. 23, 2021

(54) SYSTEMS AND METHODS FOR AUTOMATED DELIVERY DEVICES AND CARGO CONTAINERS

(71) Applicant: INTERPLAI INC., Ann Arbor, MI (US)

(72) Inventors: Mark Anthony Crawford, JR., Belleville, MI (US); Mohammad Poorsartep, Mountain View, CA (US)

(21) Appl. No.: 17/348,114

(22) Filed: Jun. 15, 2021

Related U.S. Application Data
(60) Provisional application No. 62/705,263, filed on Jun. 18, 2020.

(51) Int. Cl. B60P 1/38; B65G 67/02

(52) U.S. Cl. CPC B60P 1/38; G05D 1/0225; B65G 67/02

(57) ABSTRACT

Described herein are autonomous delivery devices for loading, transporting, and unloading cargo. In some embodiments, a delivery device includes: a first modular cargo defining a container interior for enclosing cargo therein; and a transportation platform having a plurality of wheels for transporting the first modular cargo container from an origin to a first destination. In some embodiments, a second modular cargo container may be positioned on an upper surface of the first modular cargo container for delivering a second cargo to a same of different destination. In some embodiments, the transportation microcomputer is configured to receive delivery instructions and activate the transportation platform to autonomously move towards a destination. Upon arriving at a destination, the transportation microcomputer transmits an open position electrical signal to position the rear door of the first or second cargo container in the open position, such that a cargo is unloaded at the destination.

### CROSS-REFERENCE TO RELATED APPLICATIONS

This application claims the priority benefit of U.S. Provisional Patent Application Ser. No. 62/705,263, filed Jun. 18, 2020, which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of automated delivery devices, systems and methods, and more specifically to the field of automated robotic delivery devices having a delivery device platform and a modular cargo container. Described herein are systems and methods for assembling, configuring, and operating automated delivery devices.

### BACKGROUND

Companies are struggling to adapt to changing consumer demands, such as the increase in online purchasing and the fast, cheap delivery of cargo, such as parcels, consumer products, and food items. In order to remain competitive, companies need to refine and improve their overall delivery efficiency. The last mile delivery, which is the final and most expensive step in the logistical operations of delivering cargo, is completed by drivers/deliverers operating vehicles, such as trucks, vans, or bicycles, in big cities and small towns everywhere. The last mile deliveries are currently limited by having an appropriate number of drivers for changing demands, drivers' schedules, labor costs, delays due to traffic congestion, and rising gas prices. Other issues associated with the traditional delivery methods also include increasing the risk of spreading germs and potential diseases to a receiving person as drivers/deliverers greet customers and touch their cargo while loading, transporting, and unloading.

To address these issues, systems and methods are needed that enhance and improve traditional delivery transportation and logistics.

### SUMMARY

There is a need for new and useful system and method for an autonomous delivery device for loading, transporting and unloading cargo, the delivery device. One aspect of the present disclosure is directed to an autonomous delivery device for loading, transporting, and unloading cargo. In some embodiments, the delivery device includes: a first modular cargo container for enclosing cargo, the modular cargo container defining a container interior for enclosing cargo therein; and a transportation platform having a plurality of wheels for transporting the first modular cargo container from an origin to a first destination.

In some embodiments, the modular cargo container includes a rear door that has an open and a closed position allowing access to the container interior while loading and unloading the cargo; a bottom connector for transferring and receiving power and data; and a plurality of module connectors located on a bottom surface of the first modular cargo container.

In some embodiments, the transportation platform includes a cargo receiving area connector for coupling to the bottom connector of the first modular cargo container for transferring and receiving power and data therebetween; a plurality of transportation platform active latches for locking and unlocking the plurality of module connectors of the first modular cargo container; a power system for powering at least one of the transportation platform and the modular cargo container; and a transportation microcomputer to operate the transportation platform.

In some embodiments, cargo is loaded into the container interior through the rear door in the open position, and subsequently the transportation microcomputer transmits a closed position electrical signal via the cargo receiving area connector of the transportation platform and the bottom connector of the first modular cargo container to position the rear door to the closed position.

In some embodiments, the transportation microcomputer is configured to receive delivery instructions and activate the transportation platform to autonomously move towards the first destination.

In some embodiments, upon arriving at the first destination, the transportation microcomputer transmits an open position electrical signal to position the rear door in the open position, such that the cargo is configured to be unloaded at the first destination.

In some embodiments, the delivery device further includes a second modular cargo container positioned on an upper surface of the first modular cargo container for delivering a second cargo to one of the first or a second destination.

In some embodiments, the second modular cargo container defines a second container interior and includes: a second rear door that has a second open and a second closed position allowing access to the second container body while loading and unloading the second cargo; a second bottom connector configured to connect to an upper connector of the first modular cargo container for transferring and receiving power and data; and a second plurality of module connectors located on a second bottom surface of the second modular cargo container.

In some embodiments, the second plurality of module connectors of the second modular cargo container is configured to lock to a plurality of latches on the upper surface of the first modular cargo container.

In some embodiments, the second cargo is loaded into the second container body through the second rear door in the second open position.

In some embodiments, the transportation microcomputer transmits a closed position electrical signal to the second modular cargo container via the cargo receiving area connector of the transportation platform, the bottom and upper connectors of the first modular cargo container, and the second bottom connector of the second modular cargo container to position the second rear door to the second closed position.

In some embodiments, the transportation microcomputer is configured to receive delivery instructions for the second cargo and activate the transportation platform to autonomously move towards one of the first and second destinations.

In some embodiments, upon arriving at one of the first or second destinations, the transportation microcomputer transmits an opened position electrical signal to position the second rear door to the second open position, and unload the second cargo.

In some embodiments, the first modular cargo container further comprises a conveyor belt and a conveyor actuation module for moving the conveyor belt in a first and a second direction within the first container interior.

In some embodiments, the cargo is loaded into the first container interior by positioning the cargo on the conveyor belt moving in the first direction, and the cargo is unloaded from the first container interior by moving the conveyor belt in the second direction.

In some embodiments, the first modular cargo container further comprises a disinfecting module positioned within the first modular cargo container for disinfecting at least a portion of the enclosed cargo.

In some embodiments, the first modular cargo container further comprises a cargo container microcomputer for transmitting and receiving data and processing commands.

In some embodiments, the cargo container microcomputer is configured to transmit an electrical signal to one or more actuators coupled to the rear door for moving the rear door between the open and closed positioned.

In some embodiments, the cargo container microcomputer is configured to transmit a rear door status to the transportation microcomputer.

In some embodiments, the cargo container microcomputer is configured to receive and process sensor data from one or more sensors positioned in or on the first modular cargo container.

In some embodiments, the one or more sensors comprise one or more of: a camera sensor; a temperature sensor; a humidity sensor, a proximity sensor, a pressure sensor, a level sensor, a gas sensor, an infrared sensor, or equivalents thereof.

In some embodiments, the bottom surface of the first modular cargo container and the upper surface of the transportation platform each further comprise complementary docking surfaces for aligning and docking the first modular cargo container on the transportation platform.

In some embodiments, the first modular cargo container is aligned and docked to the transportation platform by one of: manually or automatically by a cargo handling system.

Another aspect of the present disclosure is directed to a method for autonomously loading, transporting, and unloading cargo, the method being performed by an autonomous delivery device. In some embodiments, the method includes:

at a first modular cargo container: receiving a first cargo, and docking to a transportation platform;

at the transportation platform: receiving a delivery destination for the first cargo, autonomously transporting the first modular cargo container to the delivery destination, and upon arriving at the delivery destination, transmitting an arrival signal to the first modular cargo container;

at the first modular cargo container: receiving the arrival signal, transmitting an open signal to open a rear door, transmitting an unload signal to activate a conveyor belt in an unload direction to unload the first cargo, upon sensing that the first cargo was unloaded, deactivating the conveyor belt; transmitting a close signal to close the rear door, and transmitting a door status signal to the transportation platform; and

at the transportation platform: receiving the door status signal, and transporting the first modular cargo container to another location.

In some embodiments, the method further includes, at the first modular cargo container: activating the conveyor belt in a load direction to load the first cargo; sensing the loaded first cargo; and deactivating the conveyor belt.

In some embodiments, the method further includes at a second modular cargo container docked to a top surface of the first modular cargo container docked to the transportation platform: receiving a second cargo;

at the transportation platform: autonomously transporting the first and second modular cargo containers to the second delivery destination, and upon arriving at the second delivery destination, transmitting a second arrival signal to the second modular cargo container;

at the second modular cargo container: receiving the second arrival signal, transmitting an open signal to open a second rear door, activating a second conveyor belt in an unload direction to unload the second cargo, upon sensing that the second cargo was unloaded, deactivating the second conveyor belt, transmitting a close signal to close the second rear door, and transmitting a second door status signal to the transportation platform; and

at the transportation platform: receiving the second door status signal, and transporting the first and second modular cargo containers to one of the first delivery destination or another location.

In some embodiments, the method further includes, at the first modular cargo container, activating a disinfecting module positioned within the first modular cargo container and disinfecting at least a portion of the first cargo.

In some embodiments, the method further includes receiving and processing sensor data at a cargo container microcomputer.

In some embodiments, the sensor data is received from a plurality of sensors positioned in or on the first modular cargo container.

In some embodiments, the sensors comprise one or more of: a camera sensor; a temperature sensor; a humidity sensor, a proximity sensor, a pressure sensor, a level sensor, a gas sensor, an infrared sensor, or equivalents thereof.

In some embodiments, the method further includes aligning and docking, via complementary docking surfaces, the first modular cargo container on the transportation platform; and aligning and docking, via second angled docking surfaces, the second modular cargo container on the first modular cargo container.

Another aspect of the present disclosure is directed to a cargo handling system for loading, transporting, and unloading cargo from autonomously delivery devices. In some embodiments, cargo handling system includes: a system processing unit for controlling operations of the cargo handling system; and one or more modular racks, each rack comprising a rack processing unit, a frame, and one or more moveable arm sets, each rack is configured to store, dock, and undock one or more modular cargo containers according to received signals from the system processing unit.

In some embodiments, the system processing unit transmits one of:

a docking signal to an identified rack processing unit of an identified rack storing a first modular cargo container. In some embodiments, the docking signal instructs the identified rack processing unit to move a moveable arm set holding the first modular cargo container vertically in a downward direction to dock the first modular cargo container onto one of a transportation platform or a shuttle; and

an undocking signal to the identified rack processing unit of the identified rack. In some embodiments, the undocking signal instructs the identified rack processing unit to move a moveable arm set vertically in a downward direction to undock a second modular cargo container from one of the transportation platform or the shuttle and subsequently move the moveable arm set vertically in an upward direction to a storage position.

In some embodiments, the moveable arm set includes an upper arm and one or more lower arms.

In some embodiments, each arm set is configured to store a modular cargo container.

In some embodiments, the shuttle moves modular cargo containers between a first rack to a second rack.

In some embodiments, the cargo handling system further includes one or both of: markers and guides for aligning one of the transportation platform or the shuttle to a parking position within a rack.

In some embodiments, the rack is configured to dock the one or more modular cargo containers onto one of the parked transportation platform or parked shuttle and undock the one or more modular cargo containers from the parked transportation platform or parked shuttle.

In some embodiments, the rack is configured to store one of the parked transportation platforms or the parked shuttle.

Another aspect of the present disclosure is directed to a cargo handling system for managing logistical operations of storage, movement, and delivery of cargo. In some embodiments, the cargo handling system includes: a system processing unit configured to receive information related to cargo deliveries and controlling the logistical operations of the cargo handling system; one or more modular cargo containers, each modular cargo container defining a container interior for storing cargo therein for delivery to a destination; one or more transportation platforms for docking and undocking at least one modular container, and for transporting the at least one modular cargo container to one or more delivery destinations; one or more modular racks; and a parking area positioned at the bottom of the rack for parking a transportation platform.

In some embodiments, each rack includes: a rack processing unit; and a frame with a number of attached moveable arm sets. In some embodiments, each moveable arm set is configured to store a modular cargo container. In some embodiments, each moveable arm set is controllable by the rack processing unit.

In some embodiments, based on the received information related to a cargo delivery, the system processing unit transmits one of:

a docking signal to an identified rack processing unit of an identified rack that is storing an identified modular cargo container, such that the docking signal instructs the identified rack processing unit to move a moveable arm set holding the identified modular cargo container vertically in a downward direction to dock the identified modular cargo container onto a parked transportation platform; and

an undocking signal to the identified rack processing unit of the identified rack, such that the undocking signal instructs the identified rack processing unit to move a moveable arm set in a downward direction to undock the identified modular cargo container from a parked transportation platform and move the moveable arm set holding the undocked modular cargo container vertically in an upward direction to a storage position.

In some embodiments, prior to receiving the undocking signal, the parked transportation platform, having the identified modular cargo container, parks within the parking area of the identified rack and transmits a parked signal and identification data to the identified rack processing unit.

In some embodiments, the identification data identifies the transportation platform and the attached modular cargo container.

In some embodiments, a bottom surface of each modular cargo container and an upper surface of each transportation platform further includes complementary docking surfaces for aligning and docking the modular cargo container to the transportation.

In some embodiments, each modular cargo container defines a container interior and includes: a cargo container microcomputer for receiving and processing commands received from the system and rack processing units, a rear door that has an open and a closed position allowing access to the container body while loading and unloading the cargo; and a conveyor actuation module and a conveyor belt positioned in the container interior.

In some embodiments, the conveyor actuation module moves the conveyer belt in a first direction to load cargo and a second direction to unload cargo.

In some embodiments, when the system processing unit transmits a load signal to the cargo container microcomputer of the identified modular cargo container via the rack processing unit, the cargo container microcomputer transmits an open position signal to the rear door.

In some embodiments, after the cargo is loaded into the container interior, the cargo container microcomputer transmits a closed position signal to the rear door.

In some embodiments, the moveable arm set includes an upper arm and one or more lower arms.

In some embodiments, each arm set is configured to store a modular cargo container.

In some embodiments, each modular cargo container includes: a power and data transfer connector on an upper surface of the modular cargo container; a cargo container microcomputer; and a power source.

In some embodiments, a bottom surface of the upper arm includes a mating power and data transfer connector for coupling to the power and data transfer connector of the modular cargo container.

In some embodiments, power is transmitted to the power source for charging, and data is transmitted to and received from the cargo container microcomputer.

In some embodiments, the data transmitted to the cargo container microcomputer from the system processing unit includes a delivery destination address corresponding to a specific loaded cargo.

In some embodiments, the parked transportation platform is configured to receive a delivery destination address, unpark from the docking area, and autonomously transport the docked modular cargo container to the delivery destination.

In some embodiments, the system processing unit transmits a second docking signal to the identified rack processing unit of the identified rack that is storing a second identified modular cargo container.

In some embodiments, the second docking signal instructs the identified rack processing unit to lower the moveable arm set storing the second identified modular cargo container to dock the second identified modular cargo container on top of the first docked modular cargo container and the transportation platform.

In some embodiments, a delivery destination address for each of the first and second docked modular cargo containers is transferred to the parked transportation platform.

In some embodiments, the parked transportation platform processes the received data, unparks from the docking area, and autonomously transports the first and second modular cargo containers to their respective delivery destination addresses.

In some embodiments, the parking area includes one or both of: markers and guides for aligning one of the transportation platform or a shuttle in a parked position relative to the one or more modular racks.

In some embodiments, an identified rack is configured to store one of: the docked transportation platform or the shuttle.

In some embodiments, the system further includes retractable doors for enclosing the one or more modular racks and securing one or more stored modular cargo containers and one or more parked transportation platforms therein.

In some embodiments, the system further includes a shuttle for parking into a parking area of a first rack, docking an identified modular cargo container, shuttling the docked modular cargo container to a parking area of a second rack, undocking the docked modular cargo container, or a combination thereof.

Another aspect of the present disclosure is directed to a method for managing logistical operations of storage, movement, and delivery of cargo, the method being performed by a cargo handling system, modular cargo containers, and transportation platforms. In some embodiments, the method includes:

at a container processing unit of a first modular cargo container: receiving a load signal from a system processing unit of the cargo handling system to load a first cargo, such that the first modular cargo container is stored in a first rack of the cargo handling system, transmitting an open signal to open a rear door of the first modular cargo container, and sensing the loaded first cargo, and transmitting a close signal to close the rear door;

at a rack processing unit of the first rack, such that the first rack is configured to park a transportation platform in a lower parking area: receiving a docking signal from the system processing unit for docking the first modular cargo container onto a parked transportation platform, activating a moveable arm set storing the first modular cargo container and lowering the first modular cargo container to dock onto the parked transportation platform, and releasing the moveable arm set from the first modular cargo container;

at a transportation processing unit of the transportation platform: receiving the delivery destination associated with the docked first modular cargo container, unparking from the parking area of the first rack, autonomously transporting the first modular cargo container to the delivery destination, and upon arriving at the delivery destination, transmitting an arrival signal to the first modular cargo container;

at the first modular cargo container: receiving the arrival signal, transmitting an open signal to open the rear door of the first modular cargo container, activating a conveyor belt in an unload direction to unload the first cargo, sensing the unloaded first cargo, deactivating the conveyor belt; and transmitting a close signal to close the rear door of the first modular cargo container; and

at the transportation platform: transporting the first modular cargo container back to the cargo handling system.

In some embodiments, the method further includes: at a second container processing unit of a second modular cargo container, such that the second modular cargo container is stored in the first rack: receiving a second load signal to load a second cargo and a second delivery destination, transmitting a second open signal to open a second rear door of the second modular cargo container, sensing the loaded second cargo, and transmitting a second close signal to close the second rear door; and

at the rack processing unit of the first rack: receiving a second docking signal to dock the second modular cargo container onto the docked first modular cargo container, activating the moveable arm set storing the second modular cargo container, lowering the second modular cargo container to dock onto the docked first modular cargo container and the transportation platform, and releasing the second moveable arm set from the second modular cargo container;

at the transportation platform: receiving the second delivery destination for the docked second modular cargo container, autonomously transporting the first and second modular cargo containers to the second delivery destination, and upon arriving at the second delivery destination, transmitting a second arrival signal to the second modular cargo container; and

at the second modular cargo container: receiving the second arrival signal, transmitting the second open signal to open the second rear door of the second modular cargo container, activating a second conveyor belt in an unload direction to unload the second cargo, sensing the unloaded second cargo, deactivating the conveyor belt, and transmitting the second close signal to close the second rear door of the second modular cargo container.

In some embodiments, the method further includes, at the first modular cargo container, activating a disinfecting module positioned within the first modular cargo container and disinfecting at least a portion of the first cargo.

In some embodiments, the method further includes, at the transportation platform, aligning and parking the transportation platform in the parking area of the first rack using one or both of: markers and guides.

In some embodiments, the method further includes, at the transportation platform, transmitting a parked signal along with identification information of the transportation platform.

In some embodiments, the method further includes, at the rack processing unit, receiving an undocking signal from the system processing unit to undock the first modular cargo container from the parked transportation platform; and activating the moveable arm set to lower, undock, and raise the first modular cargo container to a storage position.

In some embodiments, the method further includes storing the transportation platform in the parking area of the first rack.

In some embodiments, the cargo handling system includes a plurality of racks for storing, docking, and undocking a plurality of modular cargo container, each rack having a parking area configured to park one transportation platform or one shuttle.

In some embodiments, the moveable arm set comprises an upper arm and one or more lower arms.

In some embodiments, each arm set is configured to store a modular cargo container.

In some embodiments, each modular cargo container comprises: a power and data transfer connector on an upper surface of a container body; a cargo container microcomputer; and a power source.

In some embodiments, the moveable arm set comprises an upper arm and one or more lower arms.

In some embodiments, each arm set is configured to store a modular cargo container.

In some embodiments, the upper arm includes a mating power and data transfer connector on a bottom surface for coupling with the power and data transfer connector of the modular cargo container for transmitting power to the power source for charging and transmitting data to and from the cargo container microcomputer.

In some embodiments, the method further includes shuttling, via the shuttle, an identified modular cargo container from an identified rack to another rack.

In some embodiments, the method further includes the system processing unit closing retractable doors for enclosing the one or more racks and securing the stored plurality of modular cargo containers and the docked plurality of transportation platforms.

In some embodiments, the enclosed cargo handling system is configured to autonomously travel to a second location.

In some embodiments, the transportation platform is configured to transport the docked first modular cargo container from the second location to the delivery destination.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates a diagram of an autonomous delivery device, in one embodiment of the present invention.

FIG. 2 illustrates a first perspective view of a modular cargo container 200 and a transportation platform 210 of the autonomous delivery device 100 of FIG. 1, in accordance with one embodiment of the present invention.

FIG. 3 illustrates a second perspective view of the delivery device 100 including the modular cargo container 200 and the transportation platform 210 of the autonomous delivery device 100 of FIG. 1, in accordance with one embodiment of the present invention.

FIG. 4 illustrates a third perspective view of the delivery device 100 including the modular cargo container 200 and the transportation platform 210 of the autonomous delivery device 100 of FIG. 1, in accordance with one embodiment of the present invention.

FIG. 5 illustrates the top surface of the transportation platform 210, in one embodiment of the present invention.

FIG. 6 illustrates a top surface of the modular cargo container 200, in one embodiment of the present invention.

FIG. 7 illustrates an open perspective view of the modular cargo container 200, in one embodiment of the present invention.

FIG. 8 illustrates an open bottom perspective view of the modular cargo container 200, in one embodiment of the present invention.

FIG. 9 illustrates a side open perspective view of the modular cargo container 200, in one embodiment of the present invention.

FIG. 10 illustrates an open rear perspective view of the modular cargo container 200, in one embodiment of the present invention.

FIG. 11 illustrates an open top perspective view of the modular cargo container 200, in one embodiment of the present invention.

FIG. 12 illustrates a perspective view of the sensor module 600 from the outside of the modular cargo container 200, in one embodiment of the present invention.

FIG. 13 illustrates a perspective view of the sensor module 600 from the inside of the modular cargo container 200, in one embodiment of the present invention,

FIG. 14 illustrates an example of the latches 230 and the corresponding modules connectors 430, such as strike plates, as an example of one embodiment of the present invention.

FIG. 15 illustrates an example of a pin and socket module, in accordance with one embodiment.

FIG. 16 illustrates a front perspective view of two stacked modular cargo containers 200A, 200B docked onto the transportation platform 210 of a stacked delivery system 1600, in one embodiment of the present invention.

FIG. 17 illustrates a rear perspective view of the stacked delivery system 1600, in one embodiment of the present invention.

FIG. 18 illustrates a further rear perspective view of the stacked delivery system 1600, in one embodiment of the present invention.

FIG. 19 illustrates a perspective view of one embodiment of a conveyor belt actuation module 1900 that may optionally be included in the modular cargo container 200.

FIG. 20 illustrates a perspective view of one embodiment of a disinfecting actuation module 2000 that may optionally be included in the modular cargo container 200.

FIG. 21 illustrates a top perspective view of the conveyor belt actuation module 1900 that can optionally be used with the modular cargo container 200.

FIG. 22 illustrates a rear perspective view of the conveyor belt actuation module 1900 that is within the modular cargo container 200.

FIG. 23 illustrates a top perspective view of the disinfecting actuation module 2000 that can optionally be used with the modular cargo container 200.

FIG. 24 illustrates a rear perspective view of the disinfecting actuation module 2000 that is within the modular cargo container 200.

FIG. 25 is a flowchart diagramming one embodiment of a method to dock an active component to a passive component.

FIG. 26 is a flowchart diagramming one embodiment of a method to undock an active component from a passive component.

FIG. 27 is a flowchart diagramming one embodiment of a method to load and unload cargo from the delivery system 100.

FIG. 28 illustrates one embodiment of a cargo handling module 2800 in a cargo handling system.

FIG. 29 illustrates one embodiment of the frame 2810 of the cargo handling module 2800.

FIG. 30 illustrates one embodiment of a perspective view of a top surface of the upper arm 2820 in the cargo handling module 2800.

FIG. 31 illustrates one embodiment of a perspective view of a bottom surface of the upper arm 2820 and cargo container attachment device 3010 in the cargo handling module 2800.

FIG. 32 illustrates a top view of the upper arm 2820 and a top surface of the attached cargo container attachment device 3010 in the cargo handling module 2800.

FIG. 33 illustrates a side perspective view of one of the lower arms 2830 in the cargo handling module 2800.

FIG. 34 is a top perspective view further illustrating one of the lower arms 2830 in the cargo handling module 2800.

FIG. 35 illustrates the cargo handling module 2800 configured to dock and/or undock one modular cargo container 200 and the transportation platform 210, in accordance with one embodiment of the present invention.

FIG. 36 illustrates the cargo handling module 2800 configured to dock and/or undock four modular cargo containers 200A-D onto or from the transportation platform 210, in accordance with another embodiment of the present invention.

FIG. 37 illustrates a perspective view of an extension cargo handling module 3700 of the cargo handling system, in accordance with another embodiment of the present invention.

FIG. 38 illustrates a perspective view of the cargo handling system 3800 including the cargo handling module 2800 and two extension cargo handling modules 3700A-B.

FIG. 39 illustrates one embodiment of the shuttle 3830 of the cargo handling system.

FIG. 40 illustrates the shuttle 3830 and the cargo handling module 2800 with joined extension modules 3700A-B, in one embodiment of the present invention.

FIG. 41 illustrates an embodiment of an enclosed cargo handling system 4100.

FIG. 42 illustrates an embodiment of a delivery cargo handling system 4200;

FIG. 43 illustrates an embodiment of a user interface touchscreen 4220 of the delivery cargo handling system 4200.

FIG. 44 is a flowchart diagramming one embodiment of a method to park a transportation platform 210 and undock a modular cargo container 200 in a cargo handling module 2800.

FIG. 45 is a flowchart diagramming one embodiment of a method to undock the modular cargo container 200 for storage in the cargo handling module 2800.

FIG. 46 is a flowchart diagramming one embodiment of a method to dock the modular cargo container 200 from storage in the cargo handling module 2800 onto either a transportation platform 210 or a shuttle 3830.

FIG. 47 is a flowchart diagramming one embodiment of a method to move a modular cargo container from one cargo handling module to another cargo handling module.

FIG. 48 is a flowchart diagramming one embodiment of a method to dock or undock a modular cargo container in the cargo handling system.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Similar or same reference numbers are used to refer to similar or same elements in the Figures.

As used herein, “sensors” may include any sensors known to one of skill in the art. For example, accelerometers, global positioning sensors, humidity, temperature, cameras, image sensors, radar sensors, light and detection ranging sensors, proximity sensors, microphones, vibration sensors, weight sensors, position sensors, pressure sensors, level sensor, a gas sensor, an infrared sensor, etc.

### Autonomous Delivery Devices

Disclosed herein are systems and methods for assembling, configuring and operating autonomous delivery devices that are used for transporting and delivering cargo, such as, for example, parcels and/or food products. Further, disclosed herein are systems and methods for loading, docking, transporting, unloading, and undocking the autonomous delivery devices to standard and extended handling systems. Further, disclosed herein are systems and methods for disinfecting cargo during transport, thereby protecting individuals from the spread of germs and diseases. It will be appreciated that the present invention addresses the current issues experienced with traditional delivery and logistical operations, especially delivery of cargo within the “last mile” of delivery. The “last mile” is defined as the final step in deliveries and may actually be further than one mile. Advantageously, the present invention envisions the delivery devices loading, transporting, disinfecting, and unloading cargo autonomously without the aid of drivers/deliverers, thereby allowing companies to smoothly meet changing delivery demands, increase their delivery efficiency, protect the health of others, conserve gasoline, and preserve the environment. The description is organized into systems and devices of autonomous delivery devices followed by exemplary methods performed by the autonomous delivery devices.

### Systems and Devices of the Autonomous Delivery Device

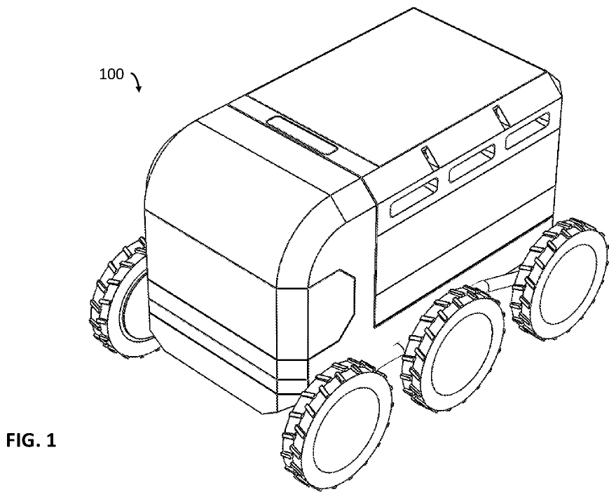

FIG. 1 illustrates a diagram of an autonomous delivery device in one embodiment of the present invention. Delivery device 100 is configured to autonomously transport cargo in indoor/outdoor environments from loading facilities to one or more final destinations. The delivery device 100 autonomously drives along pedestrian walkways and sidewalks using known autonomous delivery systems, such as GPS coordinates and location maps, while also being configured to cross roads and climb stairs. Advantageously, the delivery device 100 does not require human interaction during the transport and unloading the cargo.

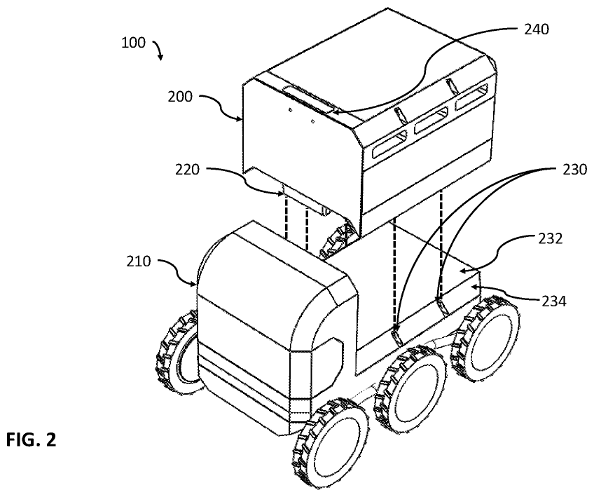

FIG. 2 illustrates a first perspective view of a modular cargo container 200 and a transportation platform 210 of the autonomous delivery device 100 of FIG. 1. The modular cargo container 200, which encloses cargo, docks onto the transportation platform 210 and transports the cargo to a drop-off location or final destination. As shown, the modular cargo container 200 and the transportation platform 210 are configured to be of sufficient size to accommodate varying sizes of cargo, such as parcels, consumer goods, food, tools, etc., while also being able to drive along traditional sidewalks and walkways. As an example of non-limiting dimensions, the modular cargo container 200 may have a width of about 15 inches to about 30 inches, a length of about 25 inches top about 35 inches, and a height of about 10 inches to about 20 inches. In this manner, the modular cargo container 200 may be configured to enclose, for example, at least one large pizza ordered from a local pizza parlor. The transportation platform 210 may be configured to travel at speeds around 10 miles per hour (mph) and climb stairs or curbs around 12 inches in height. Further, the delivery device 100 is configured to transport approximately 50 pounds (lbs) of cargo for a range of about 5 miles. The materials used to manufacture the delivery device 100 may include any material that is sufficiently rigid while maintaining the properties to facilitate its function. Some non-limiting examples of suitable materials include one or more of: plastic, metal, rubber, glass, or composite materials. It will be appreciated, however, that the specifications of the delivery device 100 are stated only as examples and can be easily altered according to the environment and end purpose.

Still referring to FIG. 2, the modular cargo container 200 includes a plug connector having a socket module 220 located on a bottom surface and a receptacle connector having a pin module 240 on a top surface. The connectors 220, 240 operate to transfer power and data to and from the modular cargo container 200 via the transportation platform 210 and/or to a cargo handling system, as described elsewhere herein. In one embodiment, when the modular cargo container 200 is docked on the transportation platform 210, the plug connector 220 mates with a corresponding receptacle connector located on a top surface of the transportation platform 210 to transfer and receive power and data related to the logistical operations. Also illustrated in FIG. 2, are latches 230, which may be active latches, on each side of a top surface of a bed or cargo container receiving area 232 of the transportation platform 210 for latching the docked modular cargo container 200, and is discussed in detail further below.

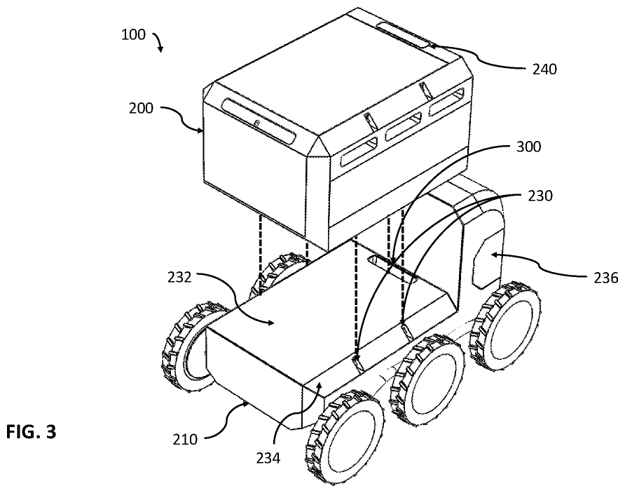

FIG. 3 illustrates a second perspective view of the delivery device 100 including the modular cargo container 200 and the transportation platform 210 of the autonomous delivery device 100 of FIG. 1. As shown, latches 230 are shown on an opposite side (as compared to FIG. 2) of the top of the cargo container receiving area 232 of the transportation platform 210. Latches 230 may be positioned on a slanted or angled surface 234 of the cargo container receiving area 232, as shown in FIGS. 2-3. Alternatively, the latches 230 may be positioned on a flat, planar, or perpendicular surface. Also shown is the mating receptacle connector 300 located on the top side of the cargo receiving area 232 of transportation platform 210. The mating receptacle connector 300 may be located adjacent to a body 236 of the transportation platform 210 or anywhere on the cargo receiving area 232 such that it can connect to the cargo positioned on the cargo receiving area 232. In this manner, when the modular cargo container 200 is docked on the transportation platform 210, the connectors 220, 300 are mated and ready for transferring power and data.

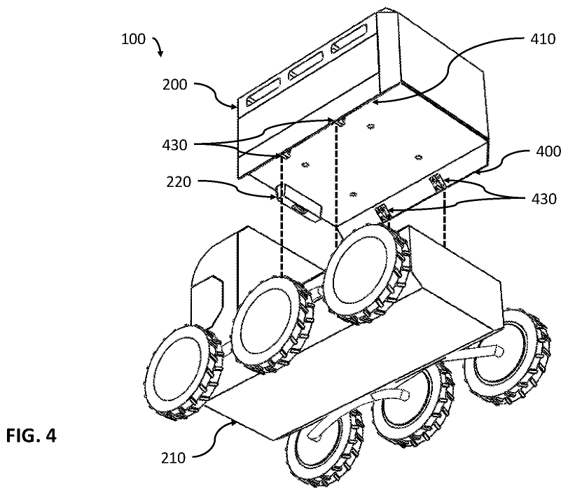

FIG. 4 illustrates a third perspective view of the delivery device 100 including the modular cargo container 200 and the transportation platform 210 of the autonomous delivery device 100 of FIG. 1. When docking the modular cargo container 200 onto the transportation platform 210, angled docking surfaces 400, 410 on each side of the container 200 are used to properly align the modular cargo container 200 on the transportation platform 210. Angled docking surfaces 400, 410 on the modular cargo container 200 are complementary to the angles surfaces 234 on the cargo receiving area 232 of the transportation platform 210, as shown in FIGS. 2-3. The plug connector having the socket module 220 mates with the receptacle connector having the pin module 300 of the transportation platform 210. It will be appreciated that the number of pins, shape, and sizing of the module connectors 220, 240 may be suitably designed and configured for any application. Also, when docking, a number of module connectors 430 on the bottom surface of the modular cargo container 200 engage the corresponding latches 230 on the top surface of the cargo receiving area of the transportation platform 210. To ensure the modular cargo container 200 is sufficiently docked to the transportation platform 210 and cannot be inappropriately taken off or fall off during transport, the latches 230 and corresponding module connectors 430 can be designed using any suitable strong connections, such as mechatronic, electrical or electromagnetic switches, strike plates or equivalents thereof. In this manner, when the modular cargo container 200 is docked, the module connectors 430 are securely engaged and locked with active latches 230. Subsequently, prior to undocking the modular cargo container 200, an undock signal, for example, an electrical signal, is transmitted from the transportation platform 210 to the latches 230 to disengage the module connectors 430, thereby allowing the release of the modular cargo container 200. It will be appreciated that the latches and corresponding module connectors can be designed so that the active latches 230 are integrated on the transportation platform 210, and the module connectors 430 are integrated on the modular cargo container 200.

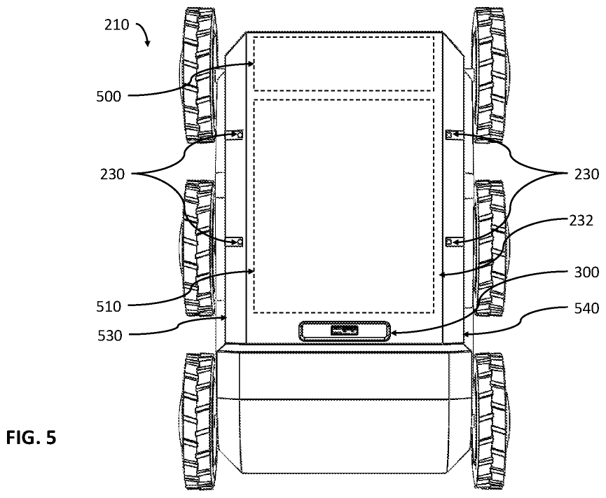

FIG. 5 illustrates the top surface of the cargo receiving area 232 of the transportation platform 210. A microcomputer 500 and power system 510 are configured to operate and power the transportation platform 210 while also controlling any power requirements or data transfers to one or more docked modular cargo containers 200. The microcomputer 500 and power system 510 may be embedded in the cargo receiving area 232, for example. Additionally, the microcomputer 500 may include a wireless radio, including a transmitter, receiver, and antenna for wirelessly communicating during the logistical operations. The microcomputer 500 controls and instructs the transportation platform 210 to drive to a destination, operate at a specific driving speed, slow down at appropriate places, such as at intersections, and stop at the destination. Additionally, the microcomputer controls any actuators and motors associated with the transportation platform 210 and the one or more docked modular cargo containers 200. In the event, the docked modular cargo container 200 requires power and/or data, the microcomputer 500 transfer the appropriate power or data signal via the pin module of the receptacle connector 300 connected to the socket module of the plug connector 220. The power system 510 powers the transportation platform 210 at several voltages, such as, for example, 24V, 12V, and 6V. Advantageously, the power system 510 may also power the one or more docked modular cargo containers 200, when necessary. Preferably, in one embodiment of the present invention, the power system 510 is rechargeable and regenerative while the transportation platform 210 drives and operates in certain conditions. In some embodiments, the power system 510 may incorporate batteries, solar panels, turbines, hub dynamos, or the like to provide energy to the system. Further illustrated in FIG. 5, are angled docking surfaces 530, 540 corresponding to the angled docking surfaces 400, 410 to properly align the modular cargo container 200 on the transportation platform 210. It will be appreciated that the angled docking surfaces may configured to be any appropriate angle, such as about 45 degrees, about 0 degrees to about 90 degrees, about 30 degrees to about 60 degrees, etc., so long as they are matching on both the modular cargo container 200 and the transportation platform 210 for a proper fit.

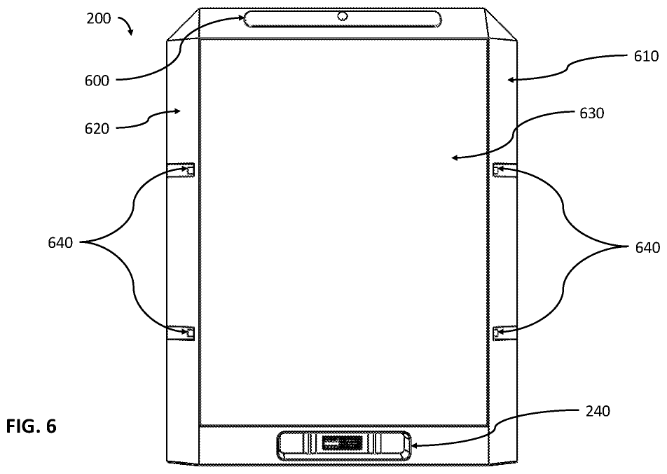

FIG. 6 illustrates a top surface of the modular cargo container 200 in one embodiment of the present invention. A sensor module 600, which is coupled to various sensors that may be located inside and outside the modular cargo container 200, is shown, and its operation is discussed further below. Angled docking surfaces 610, 620 located on the top surface are similar to the angled docking surfaces on the bottom surface of the modular cargo container 200 and used to align a second modular cargo container that may be stacked, or docked, on top of the modular cargo container 200, and then both containers 200 are docked onto the transportation platform 210. It will be appreciated that the second stackable modular cargo container is of similar dimensions and layout as the first modular cargo container 200. In this manner, the modular cargo containers 200 may include latches 640, similar to the latches 230 on the top surface of the transportation platform 210, on the top surface that are used to engage connector modules located on a bottom surface of the second modular cargo container. A top door 630, controlled manually or by the modular cargo container 200, and/or the transportation platform 210, opens and closes enabling cargo to be loaded and/or unloaded from the top. In the event that a second modular cargo container is stacked on top of the first modular cargo container 200, the top door 630 of the first container 200 would not open. Also shown is the receptacle connector 240 on the top surface that would mate to a plug connector on the stacked, or docked, second modular cargo container.

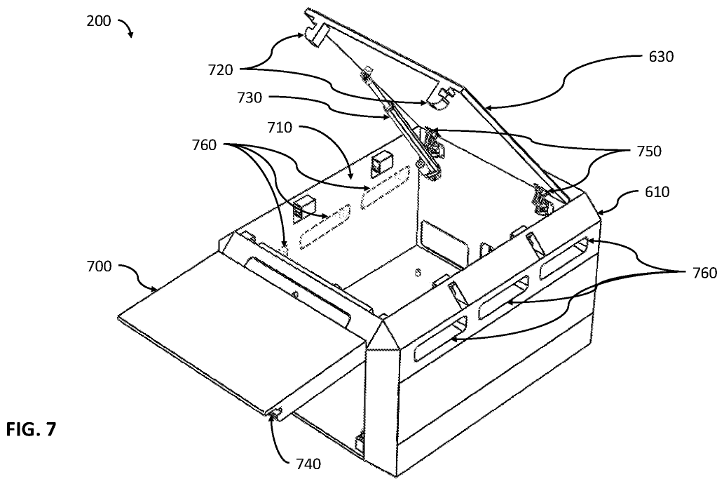

FIG. 7 illustrates an open perspective view of the modular cargo container 200. The modular cargo container may comprise a plurality of sidewalls coupled together, where one or more of the sidewalls are openable along one or more hinges. As illustrated, the top door or sidewall 630 is opened revealing a container interior 710 for enclosing and transporting the cargo and is opened and closed via top door hinges 750. Top door latches 720 actively secure the top door 630 when in the closed position. A top door linear actuator 730 opens and closes the top door 630, and is controlled by one or both of the microcomputer 500 of the transportation platform 210 and the modular cargo container 200. A rear door or sidewall 700 allows rear access to the container interior 710 and comprises latches 740 that engage with module connectors securely locking the rear door 700 in the closed position. Also shown are a number of openings 760 defined one or more sidewalls of the modular cargo container 200 that can be used for manually or automatically lifting or positioning the modular cargo container 200.

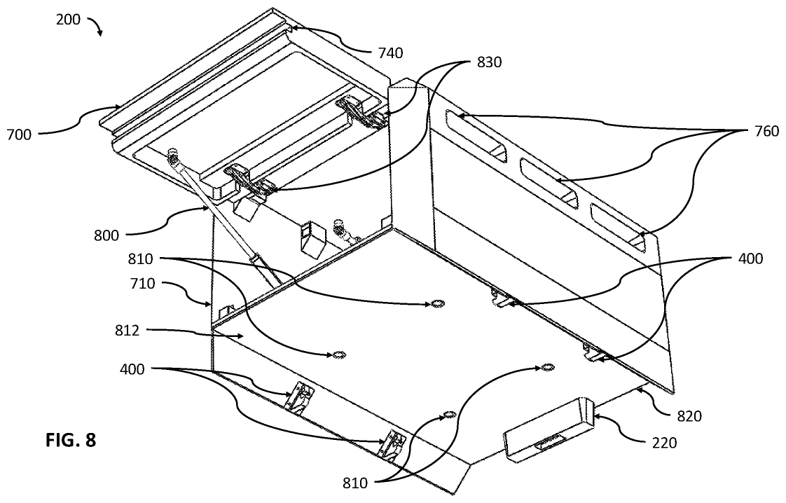

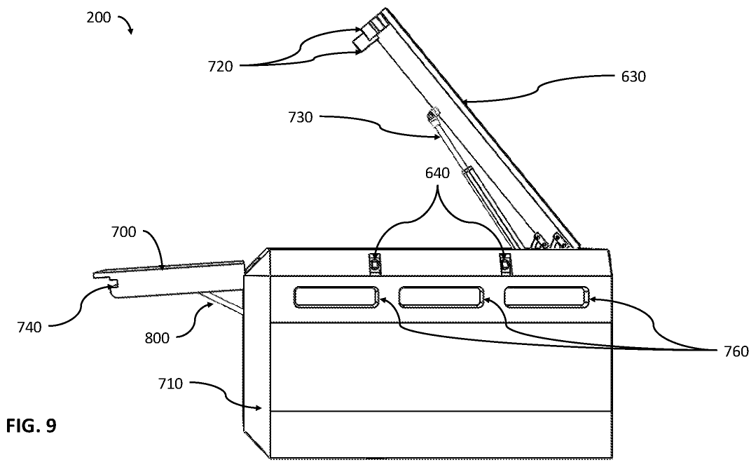

FIG. 8 illustrates an open bottom perspective view of the modular cargo container 200. A rear door actuator 800, under control of one or both of the microcomputer 500 of the transportation platform 210 and the modular cargo container 200, and two rear door hinges 830 open and close the rear door 700 allowing access to the container interior 710. In one embodiment, actuator module bolt access holes 810 are incorporated into the bottom surface or sidewall 812 of the modular cargo container 200 and discussed further below. Further, FIG. 9 illustrates a side open perspective view of the modular cargo container 200, with similarly labeled elements as shown in FIGS. 6-8.

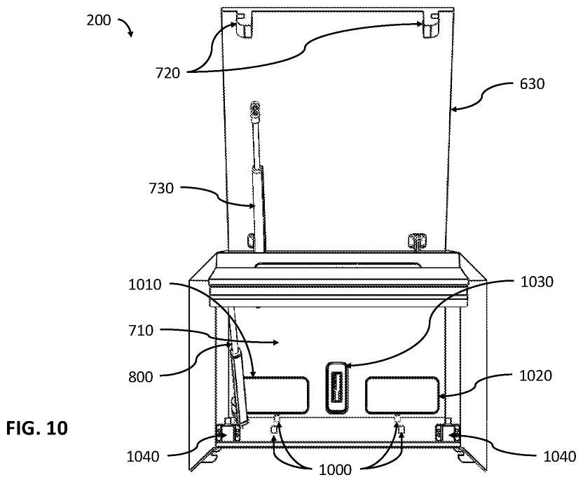

FIG. 10 illustrates an open rear perspective view of the modular cargo container 200. The modular cargo container 200 includes a microcomputer 1010 and a power system 1020. The microcomputer 1010 is configured to send and receive data as well as control various internal electronics, actuators, and sensors associated with the modular cargo container 200. As an example, the sensor module 600 transfers sensor data to the microcomputer 1010, and the microcomputer 1010 may perform one or more of the following: processing, analyzing, instructing, storing, and transmitting the sensor data. It will be appreciated that the modular cargo container 200 may also include a wireless transmitter and receiver for wirelessly communicating with the transportation platform 210 and/or other devices and systems associated with the logistical operations. A receptacle connector with an integrated pin module 1030 is included to transfer power and data to installed actuator modules, which is discussed further below. Rear door module connectors 1040 are located in the container body 710. The rear door latches 740 actively engage and disengage the module connectors 1040 to either securely lock the rear door 630 while in the closed position or release the rear door 630 for access to the container interior 710. Also shown are actuator module bolts 1000 that are positioned within the actuator module bolt access holes 810 incorporated into the bottom surface of the modular cargo container 200. These bolts 1000 are used to secure an installed actuator module in the container interior 710, and discussed further below.

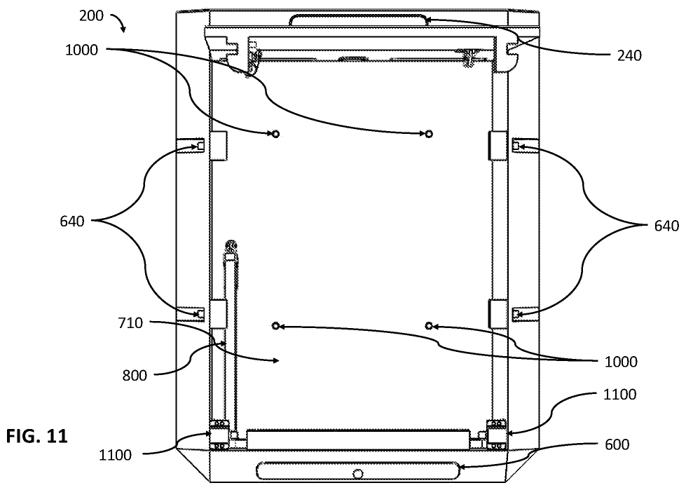

FIG. 11 illustrates an open top perspective view of the modular cargo container 200. As shown, the top door 630 is opened to reveal the container interior 710. Top door module connectors 1100 are shown that mate with latches 720. The latches 720 are controlled by the microcomputer 500 of the transportation platform 210 or the microcomputer 1010 of the modular cargo container 200, and when the top door 630 is closed, the latches 720 engage the connector modules 1100 securely locking the top door 630. When it is decided to open the top door 630 to gain access into the container body 710, a signal is transmitted to the latches 720 to disengage the connector modules 110, and the top door linear actuator 730 receives a signal to then open the top door 630.

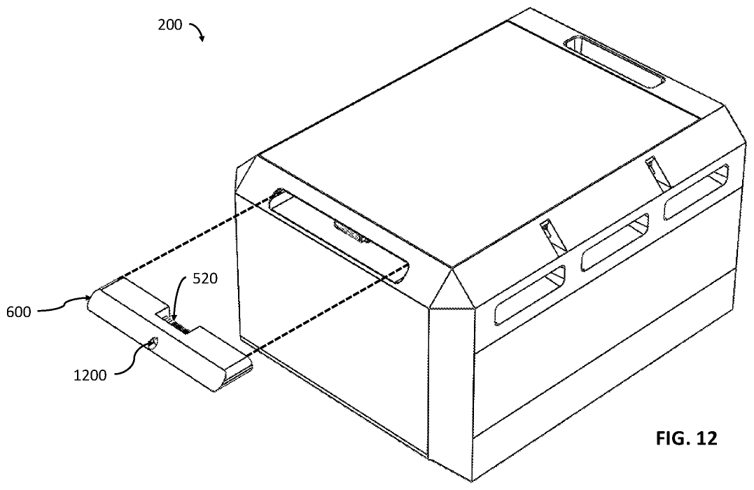

FIG. 12 illustrates a perspective view of the sensor module 600 from the outside of the modular cargo container 200. The sensor module 600 is removeable and insertable into one end of the container 200; it will be appreciated, however, that the sensor module 600 may be positioned anywhere in or on the container 200. The sensor module 600 includes a number of sensors, such as a camera or image sensor 1200 that is shown on the outside of the sensor module 600 and modular cargo container 200. The camera 1200 captures images and/or videos of the outside in front and around the modular cargo container 200. The images may be analyzed, processed and/or stored by the microcomputer 1010 of the modular cargo container 200. Data received from the images may then be transferred to the microcomputer 500 of the transportation platform 210 and/or other processing units associated with the logistical operations. In another embodiment of the invention, the images may be transferred to the microcomputer 500 of the transportation platform 210 for processing and analyzing. As a non-limiting example, images of the surrounding area captured while traveling to a destination are transferred to the microcomputer 500. In the event of an observed obstruction in the pathway received via the sensor data, the microcomputer 500 may instruct the transportation platform 210 to stop. It will be appreciated, however, that the transportation platform 210 may also include imaging sensing capabilities for driving. Other imaging examples, include capturing and recording the surroundings while unloading the cargo.

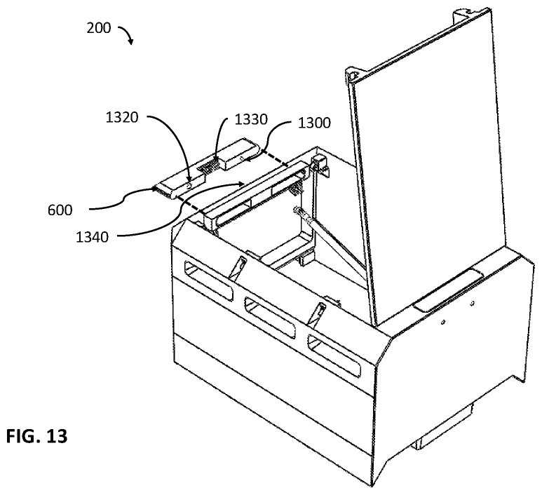

FIG. 13 illustrates a perspective view of the sensor module 600 from the inside of the modular cargo container 200. As shown, the sensor module 600 may also include an internal camera or imaging sensor 1300 that is configured to image the interior of the container body 710. Other optional sensors may include a temperature and/or humidity sensor 1320 that is configured to monitor, store, and report a temperature and humidity within the container body 710 during the time while in transit. A sensor module connector 1330 is connected to an internal sensor module connector 1340 for transferring the received data from the sensors to the microcomputer 1010 of the modular cargo container 200. It will be appreciated that other suitable sensors, such as proximity sensors, light detection sensors, or microphones, to name but a few, may be included and associated with the sensor module 600. In this manner, the microcomputer 1010 receives sensor data and may, for example, in the event of an internal temperature rising above a desired minimum temperature, activate an internal air conditioner to maintain the temperature to within the desired temperature range. Further examples include the microcomputer 1010 activating a heater, humidifier, or dehumidifier when received sensor data deviates from programmed desired specifications.

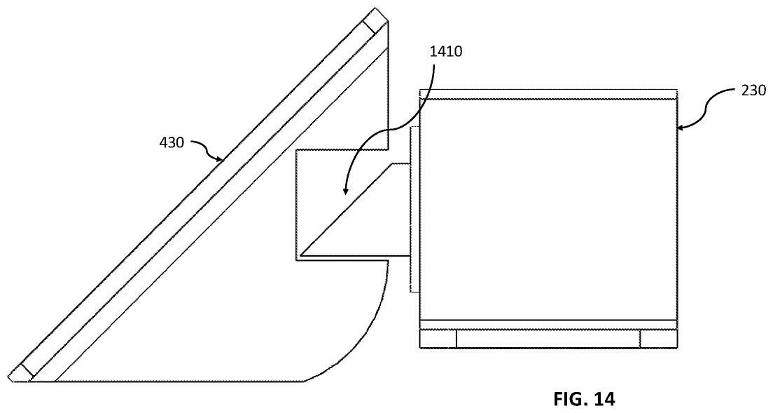

FIG. 14 illustrates an example of the latches 230 and the corresponding modules connectors 430, such as strike plates, as an example of one embodiment of the present invention. As shown, the latch 230 receives an electrical signal to disengage, or unlatch, an engaged module connector 430, and releases a bolt, or pin, 1410, thereby disengaging the module connector 430.

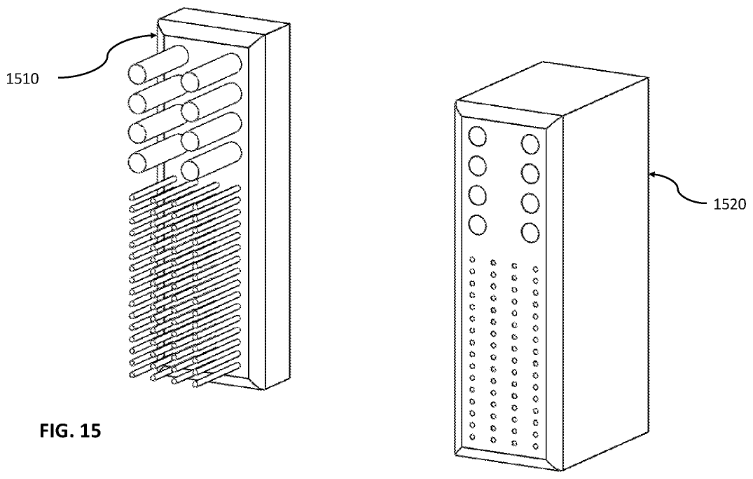

FIG. 15 illustrates an example of a pin and socket module. A pin module 1510 is shown that is suitable for use within one of the receptacle connectors 240, 300, 1030. A mating socket module 1520 is shown that is suitable for use within one of the plug connectors 220. It will be appreciated that any number or configuration of pins and sockets of the modules may be used.

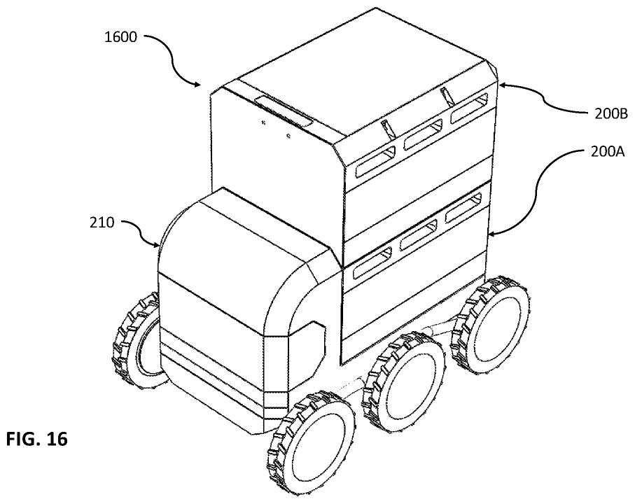

FIG. 16 illustrates a front perspective view of two stacked modular cargo containers 200A, 200B docked onto the transportation platform 210 of a stacked delivery system 1600. Due to the modular construction of the cargo containers 200, one or more individual containers 200 may be stacked on top of the other and docked onto one transportation platform 210. In this manner, the stacked delivery system 1600 is capable of carrying twice as much cargo and delivering the cargo to one or more delivery destinations. It will be appreciated that any number of modular cargo containers 200 can be stacked onto the transportation platform 210, or one large cargo container may be used.

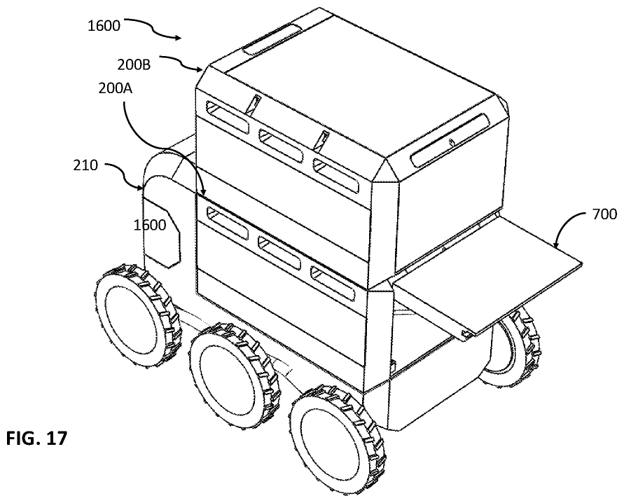

FIG. 17 illustrates a rear perspective view of the stacked delivery system 1600. As shown, and will be discussed in further detail below, the two stacked modular cargo containers 200A, 200B may be individually operated. In this manner, a first cargo associated with the first modular cargo container 200A may be first delivered and unloaded by opening the rear door 700 associated with the first modular cargo container 200A, and then a second cargo associated with the stacked second modular cargo container 200B may subsequently be delivered. It will be appreciated that the first and second cargo may be delivered to two separate destinations; however, they may also be delivered to the same destination.

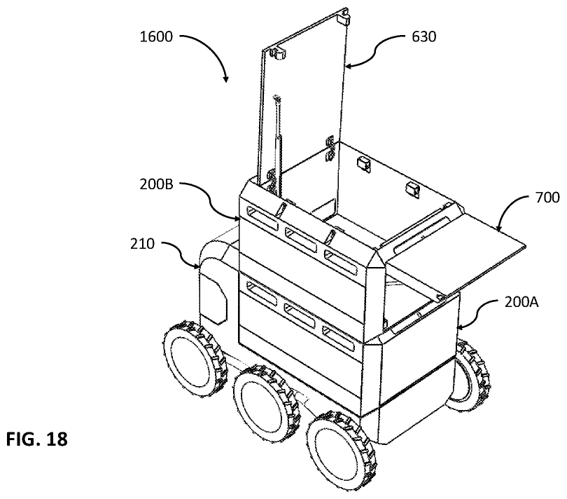

FIG. 18 illustrates a further rear perspective view of the stacked delivery system 1600. As shown, the second cargo associated with the stacked second modular cargo container 200B may be accessed independently. At the time of loading or unloading the second cargo, the microcomputer 500 of the transportation platform 210 is configured to instruct the microcomputer 1010 of their arrival at a destination, and the stacked second modular cargo container 200B actuates one or both of the linear door actuators (730, 800) to open the top door 630 or the rear door 700. In this manner, cargo can be loaded or unloaded through either door of the top stacked container 200B.

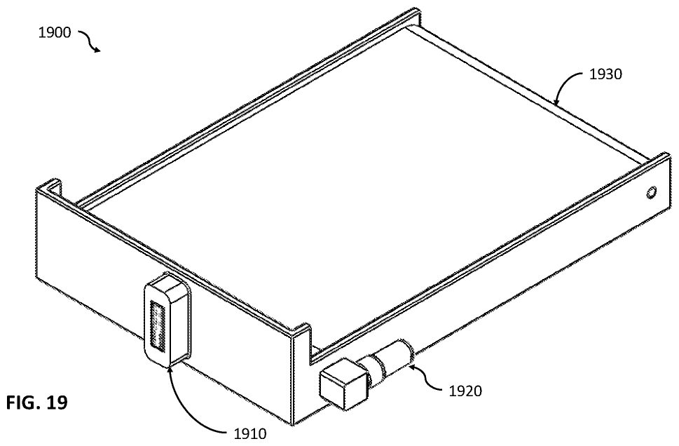

FIG. 19 illustrates a perspective view of one embodiment of a conveyor belt actuation module 1900 that may optionally be included in any of the modular cargo containers described herein. As shown in FIG. 19, the conveyor belt actuation module 1900 has a conveyor belt plug connector with an integrated socket module 1910 that connects to the actuator receptacle connector with an integrated pin module 1030, as shown in FIG. 10. When connected, power and actuation commands are received from one or both of the microcomputer 500 of the transportation platform 210 and the microcomputer 1010 of the modular cargo container 210. At the time of loading and unloading, a command is transmitted to activate and stop a motor 1920 that moves a conveyor belt 1930 in either a load direction or an unload direction. In this manner, the conveyor belt actuation module 1900 can load and unload cargo without human assistance. Further, depending on the weight and/or contents of the cargo, the speed of the conveyor belt 1930 may be controlled to perform at an optimal speed while loading or unloading. Additionally, in a non-limiting example, one or more additional sensors, such as weight, proximity, position, or pressure sensors, to name but a few, may be included in a container interior 710 or on an exterior of the modular container and associated with the sensor module 600. These sensors may detect the presence or absence of cargo, determine the cargo's weight, detect when the cargo has reached the end of the conveyor belt 1930, and/or detect when the cargo has successfully unloaded and cleared the rear door of the modular cargo container 200. Accordingly, the microcomputer 1010 of the modular cargo container 200 receives the sensor data and can stop or reverse the conveyor belt 1930 or close the rear door when unloading is complete.

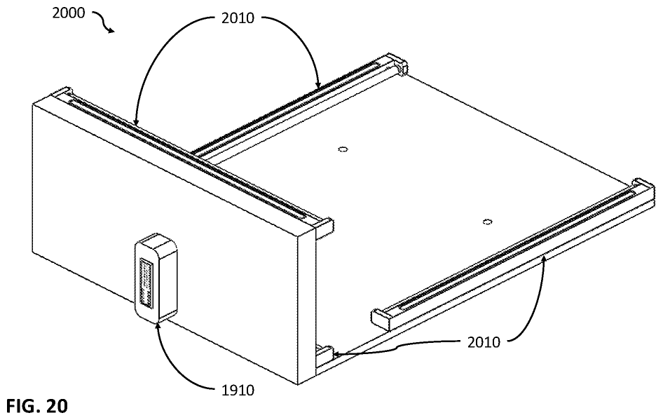

FIG. 20 illustrates a perspective view of one embodiment of a disinfecting actuation module 2000 that may optionally be included in the modular cargo container 200. Advantageously, the disinfecting actuation module 2000 includes a disinfecting mechanism 2010 (e.g., ultraviolet-c lights, disinfecting liquids or gases, or other disinfecting compositions or devices known to one of skill in the art) that, when activated, disinfect outer portions of loaded cargo while enclosed in the container interior 710. As shown, one or more disinfecting mechanisms 2010 are positioned on the sides, front top and/or front bottom, and the module 2000 is then positioned inside the modular cargo container 200. It will be appreciated, however, that the disinfecting mechanism 2010 can be positioned anywhere in the proximity of the cargo. Additionally, the disinfecting actuation module 2000 can be incorporated with the conveyor belt activation module 1900 for a combined disinfecting conveyor belt actuation module. Further, in a non-limiting example, one or more additional sensors, such as weight, proximity, position, or pressure sensors, to name but a few, may also be included in a container interior 710 or on an exterior of the modular container to detect the presence or absence of cargo, determine the cargo's size, and/or detect when the doors are closed and locked. Accordingly, the microcomputer 1010 of the modular cargo container receives the sensor data and can activate and deactivate the disinfecting mechanism 2010 for the disinfection process.

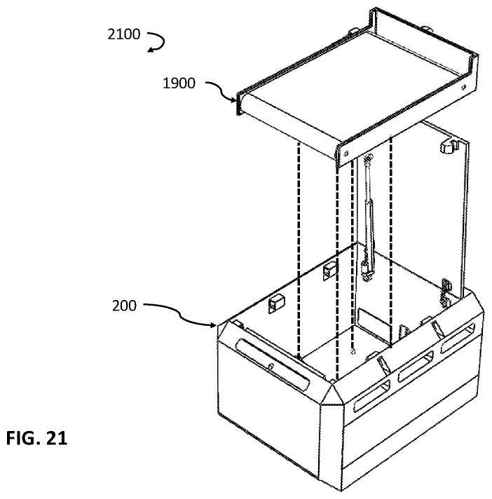

FIG. 21 illustrates a top perspective view of the conveyor belt actuation module 1900 that can optionally be used with the modular cargo container 200. The module 1900 is positioned in the container interior 710, for example on a bottom sidewall. The actuator module bolt access holes 810 (FIG. 8) and bolts 1000 (FIG. 10) may be used to firmly position the module 1900 in the container 200.

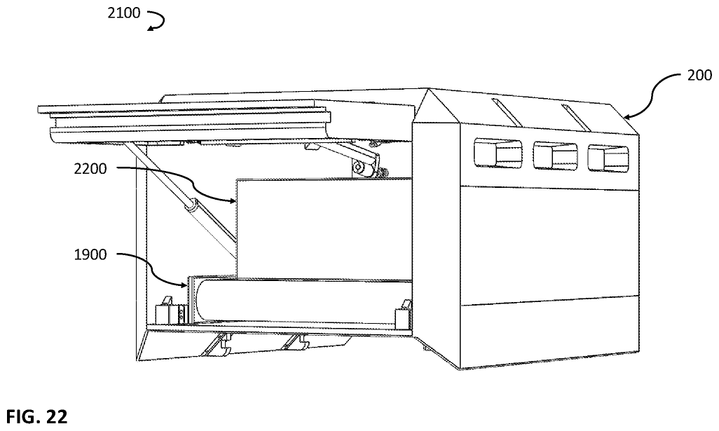

FIG. 22 illustrates a rear perspective view of the conveyor belt actuation module 1900 that is within the modular cargo container 200. As shown, cargo 2200 is placed on the conveyor belt 1930. In this manner, the cargo 2200 may be loaded or unloaded through the opened rear door 700 depending upon the direction of the conveyor belt 1930. Alternatively, or additionally, conveyor belt actuation module 1900 may also be configured to raise and lower cargo (e.g., via a controlled piston, spring, or jack mechanism) for loading and unloading cargo through a top door or sidewall.

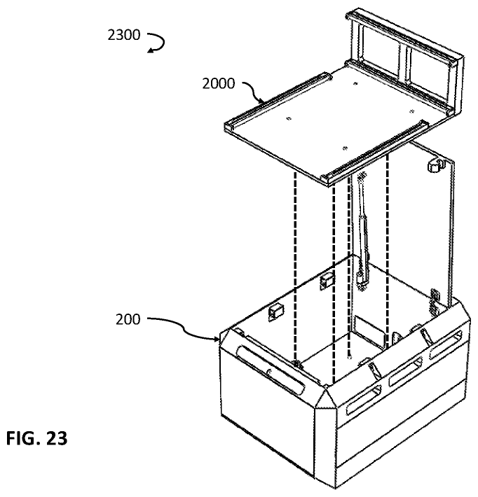

FIG. 23 illustrates a top perspective view of the disinfecting actuation module 2000 that can optionally be used with the modular cargo container 200. The module 2000 is positioned in a the container interior 710, for example, on a bottom sidewall of the cargo container. The actuator module bolt access holes 810 (FIG. 8) and bolts 1000 (FIG. 10) may be used to firmly position the module 2000 in the container 200.

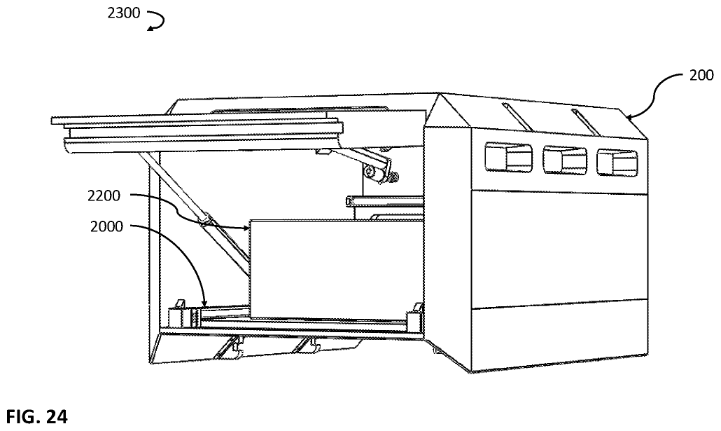

FIG. 24 illustrates a rear perspective view of the disinfecting actuation module 2000 that is within the modular cargo container 200. As shown, cargo 2200 is placed on the module 2000 with the disinfecting mechanism encompassing the outside package of the cargo 2200. In this manner, when the rear and top doors are closed, the cargo 2200 is disinfected prior to delivering to the end customer.

### Exemplary Methods of the Autonomous Delivery Device

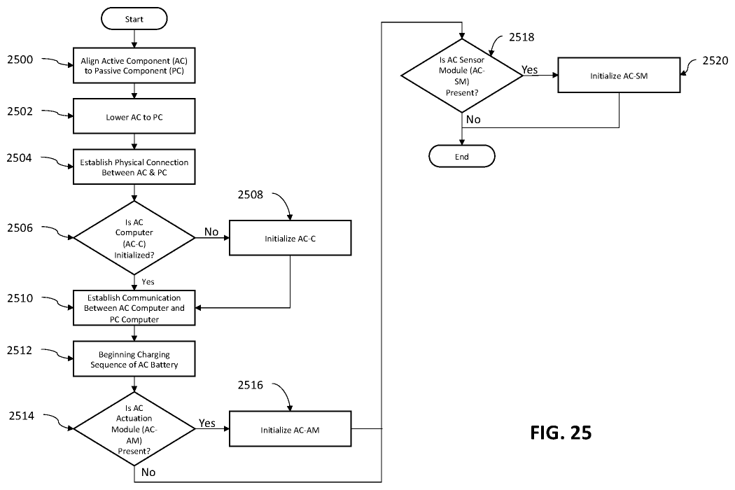

FIG. 25 is a flowchart diagramming one embodiment of a method to dock an active component to a passive component. It will be appreciated that either the modular cargo container 200 or the transportation platform 210 can be considered the active component (AC) or the passive component (PC). In any application, the roles can be configured to equally reverse as an active or passive component. Referring to FIG. 25, at block 2500, the AC is aligned to the PC, and, at block 2502, the AC is lowered onto the PC (e.g., modular cargo container is lowered onto transportation platform). A physical connection is established between the AC and the PC at block 2504. At block 2506, the microcomputer of the AC is checked for initialization, and, if not, at block 2508, the microcomputer is initialized. At block 2510, with the microcomputer initialized, communication with the microcomputer of the PC is established. At block 2512, the microcomputer of the AC begins a charging sequence. The microcomputer of the AC then checks for the presence of an actuation module, at block 2514, such as the conveyor belt actuation module or the disinfecting actuation module. If one is present, the microcomputer initializes the actuation module at block 2516. The microcomputer of the AC then checks for the presence of the sensor module at block 2518. If one is present, the microcomputer initializes the sensor module at block 2520.

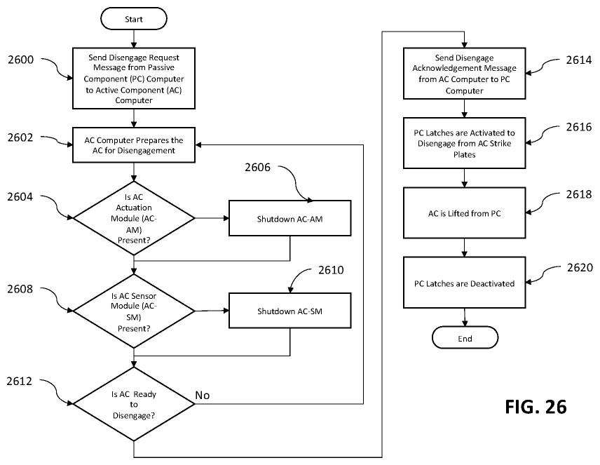

FIG. 26 is a flowchart diagramming one embodiment of a method to undock an active component from a passive component. As shown at block 2600, a disengage message signal is transmitted from the PC to the AC. The microcomputer of the AC prepares for disengagement at block 2602. At block 2604, the microcomputer checks for the presence of the actuation module (e.g., for actuating doors of the modular cargo container, the conveyor belt, the disinfecting module, etc.), and, if present, at block 2606, powers down the actuation module. The microcomputer of the AC then checks for the presence of the sensor module, and, if present, at block 2610, powers down the sensor module. At block 2612, the microcomputer verifies that the AC is ready to disengage, and if not, the microcomputer sends a signal returning to block 2602 to prepare for disengagement. If AC is ready to disengage, at block 2514, the microcomputer sends a disengage acknowledgement message signal to the microcomputer of the PC. At block 2616, the PC latches are disengaged from the AC module connectors. The AC is lifted from the PC, at block 2618, and the PC latches are deactivated in block 2620.

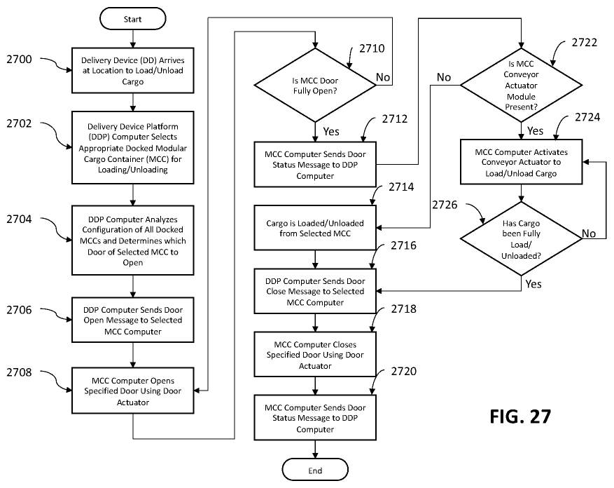

FIG. 27 is a flowchart diagramming one embodiment of a method to load and unload cargo from the delivery system 100. As shown at block 2700, the delivery system 100 arrives at a delivery destination to either load or unload cargo. In the event that the delivery system 100 has multiple modular cargo containers stacked on the transportation platform 210, the microcomputer 500 of the transportation platform 210, at block 2702, selects the appropriate docked modular cargo container (200A or 200B). At block 2704, the microcomputer 500 analyzes the configuration of the stacked containers and determines which door of the modular cargo container to open. In some embodiments, each cargo container may have a unique identifier (e.g., serial number, barcode, tag, etc.), for example stored in memory or otherwise stored or positioned thereon, such that the unique identifier is readable by microcomputer 500 to determine which containers are present, which configuration the containers are in, etc. For example, if the cargo is within the container 200A, the rear door of container 200A is selected. If, on the other hand, the cargo is within the container 200B, then one or both of the rear door or top door of container 200B is selected. Further, if the cargo within container 200B is to be autonomously unloaded, then the rear door is selected, for example by activating the conveyor belt actuation module and unloading the cargo on the moving conveyor belt. At block 2706, the microcomputer 500 transmits a door open signal to the selected modular cargo container, and, at block 2708, the microcomputer 1010 of the selected modular cargo container activates the actuators to open the rear or top door. At block 2710, the microcomputer 1010 ensures the door is fully open, and, if not, returns to block 2708. At block 2712, the microcomputer 1010 sends a door status message to the microcomputer 500 of the transportation platform 210. At block 2722, the microcomputer 1010 checks for the presence of the conveyor belt actuation module. If not present, at block 2714, sensors sense that the cargo has been loaded or unloaded from the selected modular cargo container. Alternatively, a user interface may be incorporated into the modular cargo container 200, or the transportation platform coupled thereto, that is configured to receive an input signal signifying the process of unloading or loading is complete. At block 2716, a door close message is sent to the selected microcomputer 1010, at block 2718, the microcomputer 1010 closes the door, and finally, at block 2720, the microcomputer 1010 sends a door status message notifying the microcomputer 500 that the door is fully closed and locked. At block 2722, if the presence of the conveyor belt actuator module is present, at block 2724, the microcomputer 1010 activates the motor to move the conveyor belt in one direction or the other depending on whether the cargo is being loaded or unloaded. At block 2726, sensors sense that the cargo has been fully loaded or unloaded and moves to block 2716 to continue the process.

Advantageously, embodiments of the devices and systems of the present invention include a delivery device that is easily reconfigurable and expandable in order to meet the delivery needs of companies and individuals while offering numerous improvements to the logistical operations. In particular, one or more cargo containers can be stacked and delivered by one autonomous transportation platform saving on costs and improving the speed and efficiency of deliveries. The dimensions or shapes of the modular cargo containers can vary, as well as the materials used for their construction. For example, a larger modular cargo container can be used as well as any number of smaller stacked containers. Additionally, different types of actuation modules, similar to the conveyor belt and disinfecting actuation modules, such as temperature and humidity control actuation modules, are envisioned and easily installable for any situation or environment. The delivery devices may be used for numerous different applications, such as consumer delivery, food delivery, construction environments, person-to-person deliveries, etc. In addition to delivering cargo of some type, the autonomous devices may also be used for security patrols or other types of reconnaissance. More specifically, utilizing the microcomputers, sensors, transmitters, and receivers, the devices may be configured to patrol various areas, receive images, sounds, environment data, etc. using the onboard sensors, and wirelessly communicate all that is sensed.

### An Exemplary Cargo Handling System

An embodiment of the present invention also envisions a cargo handling system including one or more cargo handling modules for storing, docking and undocking a number of modular cargo containers onto transportation platforms. Further, disclosed herein are systems and methods for parking, docking, transporting, unparking, and undocking the autonomous delivery devices to standard and extended cargo handling systems. Additionally, the cargo handling system is configured to store a number of transportation platforms. There may be a number of cargo handling modules in the overall logistical operation. For example, a number of the modules may be permanent fixtures as part of a warehousing operation, and a number of the modules may be autonomously transportable to a destination, such as another warehouse facility or a central point in a neighborhood where the delivery devices 100 begin their “last mile” deliveries. Additionally, the cargo handling system and modules may optionally be autonomous and configured to operate without the aid of humans and/or configured to partially interact with humans depending upon the application. The description is organized into systems and devices of the cargo handling system followed by exemplary methods performed by the cargo handling system.

### Systems and Devices of a Cargo Handling System

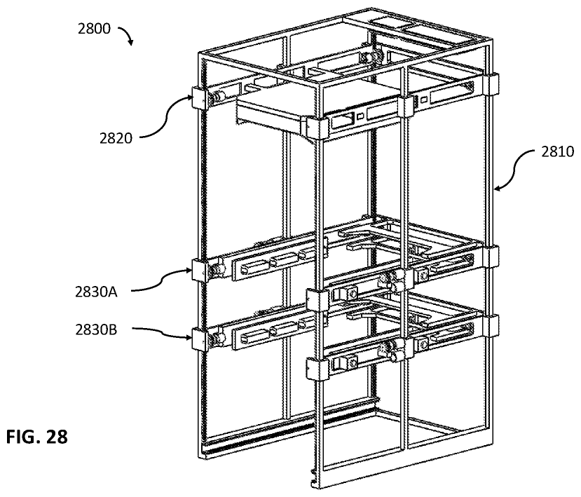

FIG. 28 illustrates one embodiment of a cargo handling module 2800 in a cargo handling system. As shown, a cargo handling module 2800 includes a frame 2810 and a number of arms 2820, 2830. The cargo handling module 2800 is configured to store, dock, and undock one or more modular cargo containers 200. Additionally, a cargo handling module 2800 is configured to store and transport the transportation platform 210. The cargo handling module 2800 includes an upper arm 2820 that is configured to attach to the top surface of the modular cargo container 200 and preferably at least two lower arms 2830A-B, each for holding, lifting, and lowering a number of modular cargo containers 200 and a transportation platform 210. It will be appreciated and discussed further below that the arms 2820, 2830 are individually controlled and operate independent of one another.

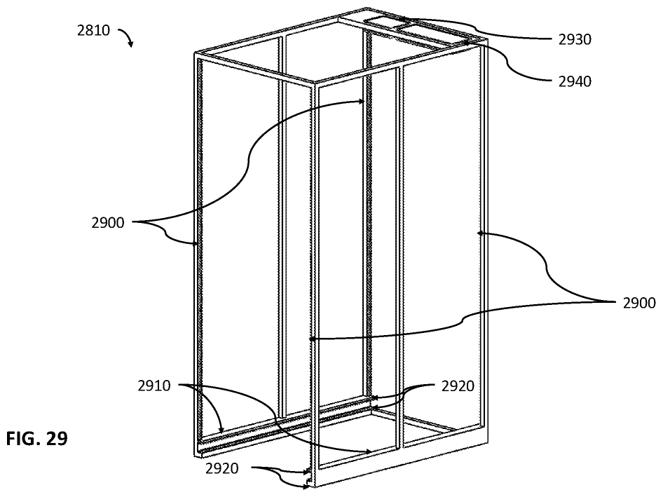

FIG. 29 illustrates one embodiment of the frame 2810 of the cargo handling module 2800. In one embodiment, the frame 2810 is configured with a gear-toothed insert 2900 for moving the arms 2820, 2830 vertically (i.e., up and down in frame). Channels 2910 positioned horizontally along the bottom sides of the frame 2810 also have gear-toothed inserts 2920 for horizontal movement in the cargo handling module 2800, and is discussed in detail further below. A module microcomputer 2930 and frame power system 2940 are installed in the frame 2810 for independently operating the arms 2820, 2830 and for transmitting and receiving data and powering coupled modular cargo containers 200 and transportation platforms 210. Although a particular frame structure and motor assembly is described, one of skill in the art will appreciate that any complementary frame structure and motor assembly is envisioned.

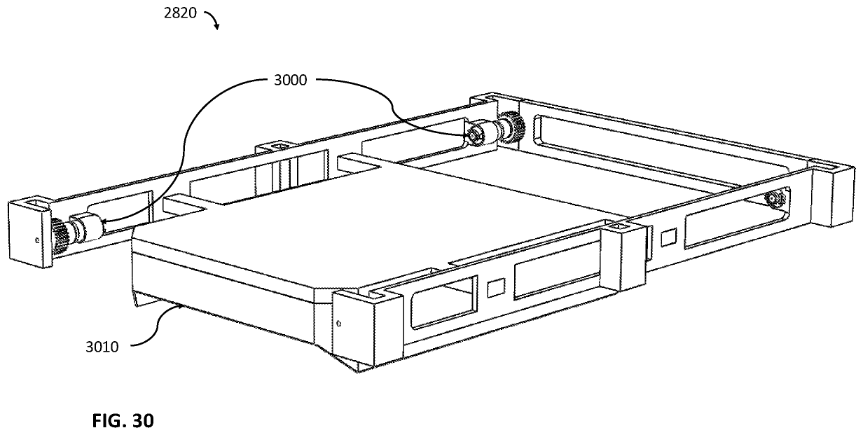

FIG. 30 illustrates one embodiment of a perspective view of a top surface of the upper arm 2820 in the cargo handling module 2800. The upper arm 2820 includes a number of motor assemblies 3000 that receive a signal to either raise or lower the upper arm 2820 on the gear-toothed insert 2900. When the modular cargo container 200 is stored or docked in the cargo handling module 2800, a cargo container attachment device 3010 attached to the upper arm 2820 is connected to the top surface of the modular cargo container 200.

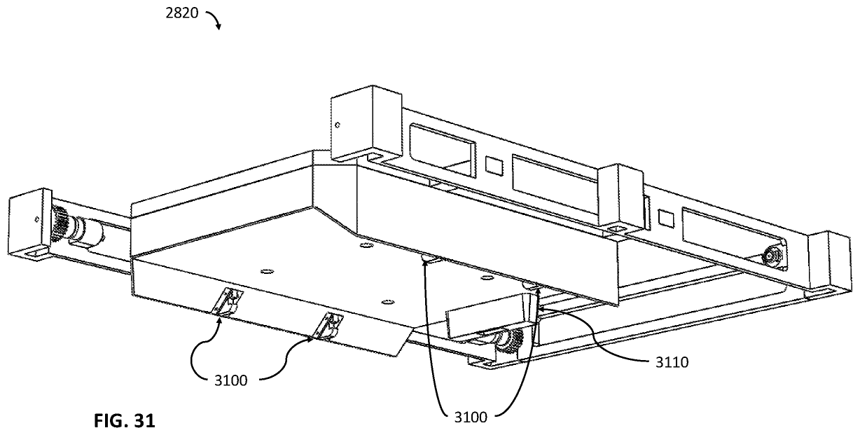

FIG. 31 illustrates one embodiment of a perspective view of a bottom surface of the upper arm 2820 and cargo container attachment device 3010 in the cargo handling module 2800. As shown, module connectors 3100, such as strike plates, on a bottom surface of the cargo container attachment device 3010 are configured to engage with the latches 640 (shown in FIG. 6) of the modular cargo container 200 in a similar way as discussed earlier in the description. Further, a plug power and data transfer connector 3110 is configured to connect with the upper receptacle power and data transfer connector 240 (shown in FIG. 6). In this manner, when the upper arm attaches to the top surface of the modular cargo container 200, the latches 640 engage the module connectors 3100, and the connectors 240 and 3110 physically connect enabling power and data transfer among any coupled devices.

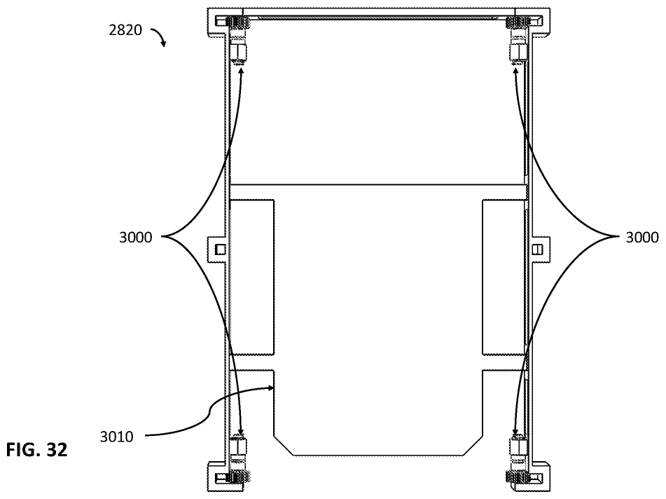

FIG. 32 illustrates a top view of the upper arm 2820 and a top surface of the attached cargo container attachment device 3010 in the cargo handling module 2800. Also shown are the motor assemblies 3000 that operate to move the upper arm 2820 vertically along the gear-toothed insert 2900.

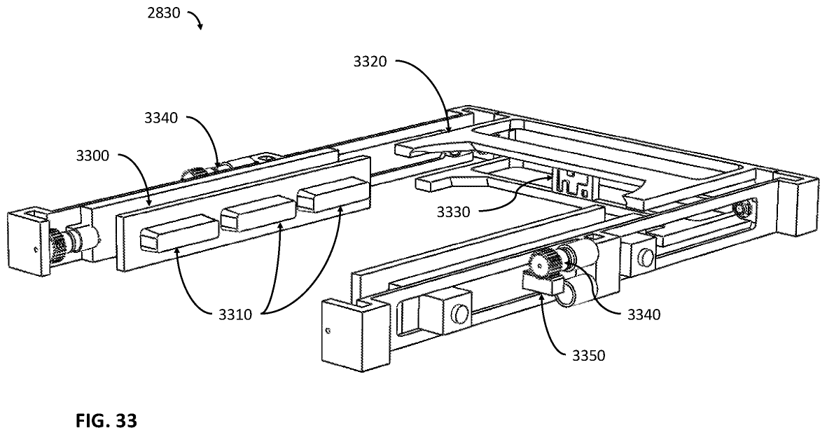

FIG. 33 illustrates a side perspective view of one of the lower arms 2830 in the cargo handling module 2800. As shown, horizontal extenders 3300 extend inward for inserting integrated plugs 3310 into the number of openings 760 (shown in FIG. 7) in order to lift, lower and store the modular cargo container 200 and/or the transportation platform 210. The horizontal extenders 3300 are then returned to a resting position after releasing the container 200 or transportation platform 210. One or more motor assemblies 3340 operate on an extension rack 3350 and are used to extend inwardly and return the horizontal extenders 3300. Device guides 3320 and a fiducial marker 3330 are included in the lower arm 2830 to aid in identifying and guiding the transportation platform 210 into the module 2800.

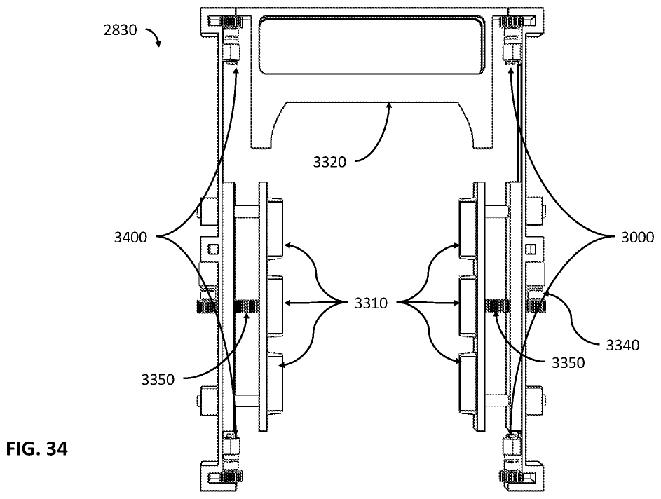

FIG. 34 is a top perspective view further illustrating one of the lower arms 2830 in the cargo handling module 2800. In one embodiment, the transportation platform 210 enters a bottom area of the cargo handling module 2800 having a desired fiducial marker 3330, or some other identifying marker, and, using the device guides 3320, parks in the module 2800. Once in a parked position, the microcomputer 500 of the transportation platform 210 notifies the module microcomputer 2930 of the cargo handling module 2800, and the arms 2820, 2830 are lowered to either dock or undock modular cargo containers 200.

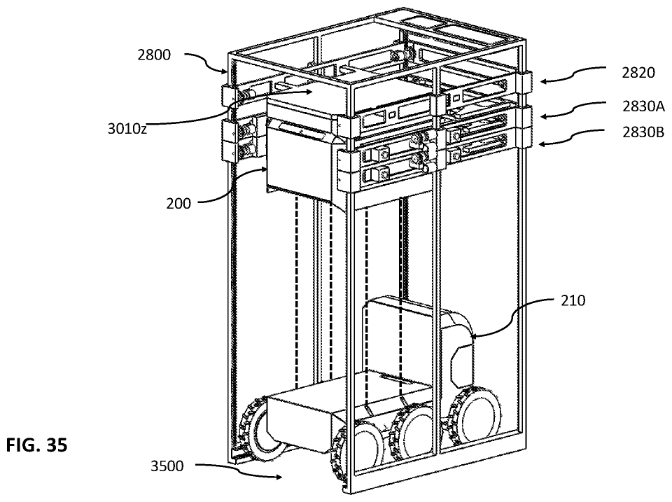

FIG. 35 illustrates the cargo handling module 2800 configured to dock and/or undock one modular cargo container 200 and the transportation platform 210 in accordance with one embodiment of the present invention. As shown in a docking example, the transportation platform 210 is in the parked position at the bottom area 3500 of the cargo handling module 2800. The module microcomputer 2930 activates the motor assemblies 3000 of the upper arm 2820 and the motor assemblies 3400 (shown in FIG. 34) of the lower arms 2830A-B to lower to the modular cargo container 200. The connector 3110 (shown in FIG. 31) of the upper arm 2820 is attached to the connector 240 (shown in FIG. 2) on the top side of the modular cargo container 200. The lower arms 2830A-B lower to a point where the horizontal extenders 3300 of the lower arms 2830A can extend inward thereby inserting the plugs 3310 into the openings 760 defined by one or more sidewalls of the modular cargo container 200 and can lift the modular cargo container 200. All arms 2820, 2830A-B are lifted to an undocked, storage position. It will be appreciated that the module connectors and latches as earlier discussed are also signaled to disengage, thereby allowing the release of the modular cargo container 200 from the transportation platform 210.

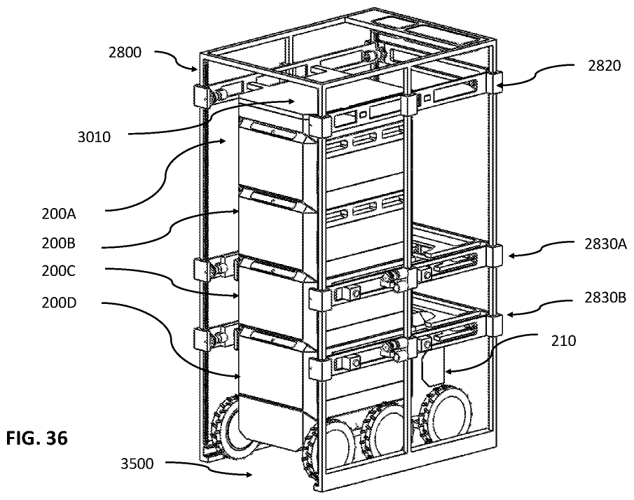

FIG. 36 illustrates the cargo handling module 2800 configured to dock and/or undock four modular cargo containers 200A-D onto or from the transportation platform 210. As shown in this non-limiting example, the transportation platform 210 is parked in the bottom area 3500 of the cargo handling module 2800. As shown, the cargo handling module 2800 may either dock, undock, or store the four modular cargo containers 200A-D. The cargo container attachment device 3010 of the upper arm 2820 is attached to the top side of the uppermost stacked modular cargo container 200D. The horizontal extenders 3300 (FIG. 33) of each of the lower arms 2830A-B are each extended inward thereby inserting the plugs 3310 into the openings 760 of the lowest stacked modular cargo containers 200C, 200D. It will be appreciated that one or some or all of the modular cargo containers 200A-D can be docked onto the transportation platform 210 for transport. Additionally, one or some or all of the modular containers 200A-D can be undocked, and, in some instances, one or more transportation platforms 210 can enter the cargo handling module 2800 at different times to dock or undock one or more modular cargo containers 200A-D.

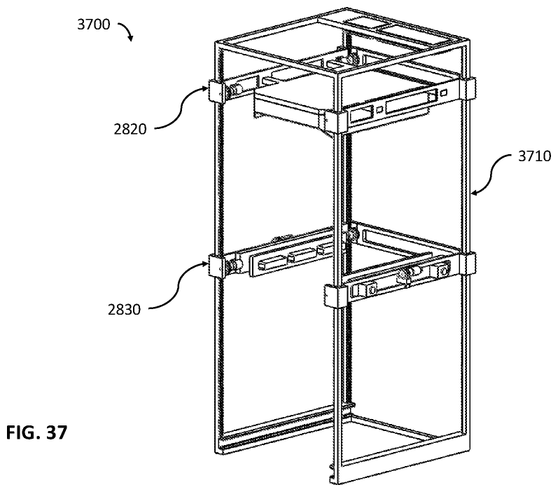

FIG. 37 illustrates a perspective view of an extension cargo handling module 3700 of the cargo handling system. It is envisioned that a number of extension cargo handling modules, similar to the illustrated extension cargo handling module 3700, can be horizontally aligned and connected to one another in order to add storage depth to the cargo handling system. Similarly, the extension cargo handling module 3700 has the upper arm 2820 and one or more lower arms 2830 on an extension frame 3710. Additionally, the extension cargo handling module 3700 can include a module microcomputer and power system for that module 3700.

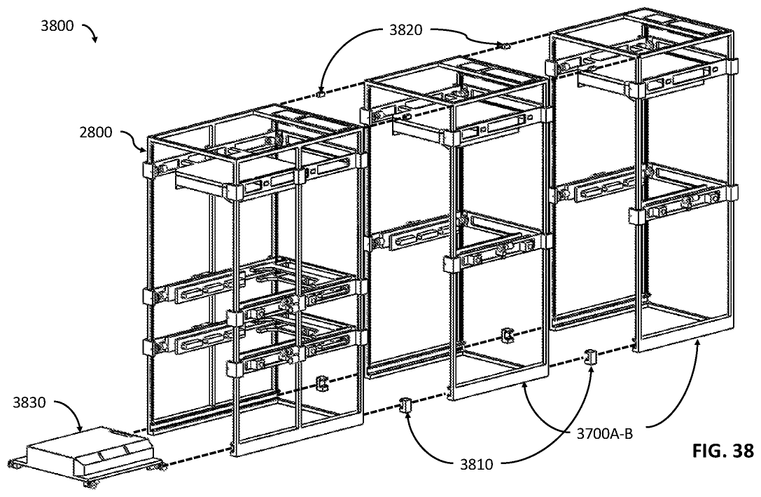

FIG. 38 illustrates a perspective view of the cargo handling system 3800 including the cargo handling module 2800 and two extension cargo handling modules 3700A-B. It will be appreciated that two modules 3700A-B are illustrated; however, any number of extension modules can be incorporated into the present invention. As illustrated, the cargo handling module 2800 and the extension modules 3700A-B are aligned and joined using bottom frame channel connectors 3810 and upper frame connectors 3820. A shuttle platform 3830 is shown that is configured to shuttle among the horizontally joined modules 2800, 3700A-B on channels having gear-toothed inserts, such as channel 2910 (shown in FIG. 29) having gear-toothed inserts 2920 (shown in FIG. 29), that run along the bottom sides of the cargo handling module 2800 and the extension modules 3700A-B.

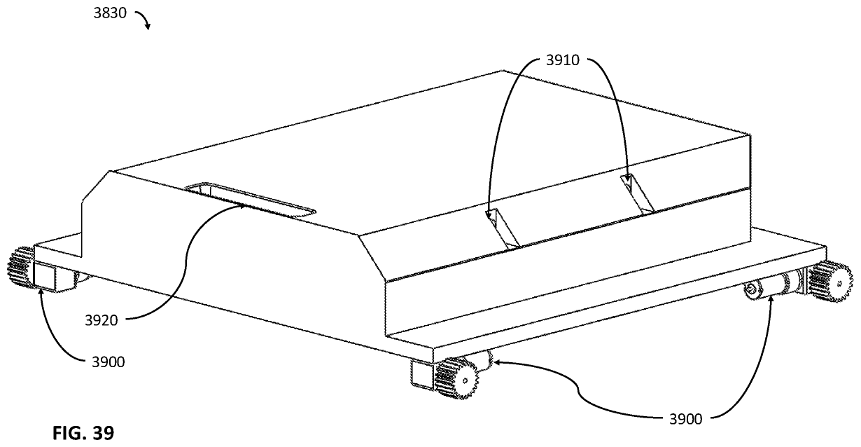

FIG. 39 illustrates one embodiment of the shuttle 3830 of the cargo handling system. The shuttle 3830 is configured to shuttle, or move, modular cargo containers 200 from one cargo handling module to another joined module. More specifically, in conjunction with FIG. 38, the shuttle 3830 moves a docked modular cargo container 200 from, for example, module 2800 to one of the joined extension modules 3700A-B for storage. Motor assemblies 3900 operate attached mating gear-toothed wheels to travel forward and backward along the gear-toothed inserts 2920 within the channels 2910 (FIG. 29) of the frames 2810 (FIG. 29). Latches 3910 and a receptacle power and data transfer connector 3920 are integrated on a top surface of the shuttle 3830 configured to engage the module connectors and connect to the plug power and data transfer connector, respectively, which are located on the bottom side of the modular cargo container 200.

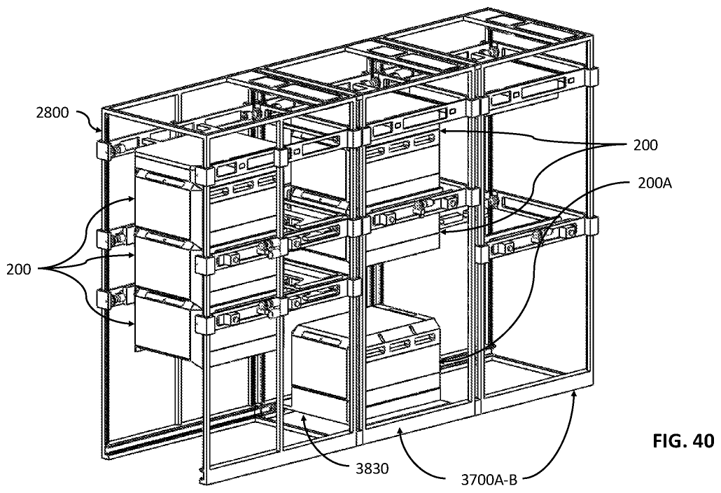

FIG. 40 illustrates the shuttle 3830 and the cargo handling module 2800 with joined extension modules 3700A-B. As shown, modular cargo containers 200 are stored in the modules 2800, 3700A. One modular cargo container 200A is docked on the shuttle 3830 in order to move it from one module to another. For example, the shuttle 3830 may move the modular cargo container 200A from cargo handling module 3700A to the second cargo handling module 3700B. It will be appreciated that the modular cargo container 200A is docked onto the shuttle 3830 in a similar manner as docking onto the transportation platform 210.

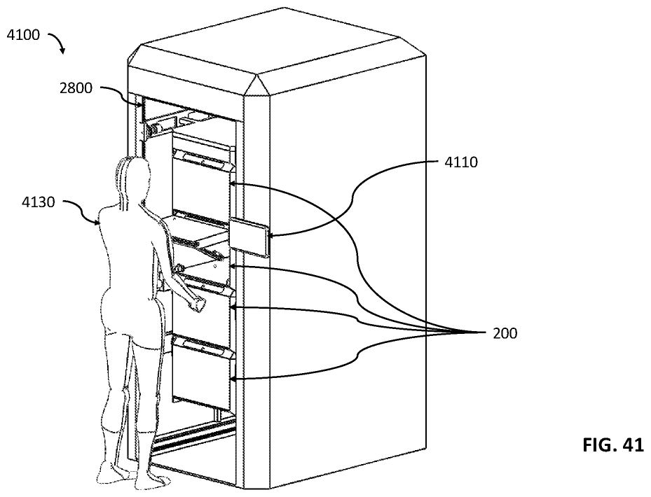

FIG. 41 illustrates an embodiment of an enclosed cargo handling system 4100. As shown, the cargo handling module 2800 and a number of modular cargo containers 200 are enclosed in the cargo handling system 4100. It will be appreciated that there may be one or more extension modules joined to the cargo handling module 2800. A user interface touchscreen 4110, which communicates with the module microcomputer 2930, is shown that is configured to interact with a human 4130 for manual operations of the system 4100, if desired. Alternatively, a computing device (e.g., mobile computing device, server, cloud, laptop, desktop, etc.) may be communicatively coupled to the enclosed cargo handling system 4100 such that a user can remotely communicate with the system 4100 to indicate a pickup time, to check whether their parcel is in the system 4100 (has arrived), to authenticate the user for the parcel pickup, etc. Further, any of the embodiments described herein, transportation platforms and/or modular cargo containers, may be configured for remote or wireless communication such that instructions (e.g., delivery address, conditions for delivery, etc.) or data may be transmitted to or received from the Cloud or a server and/or a computing device, for example for instructions or authentication received form a user. A computing device may include an application downloaded thereon through which to communicate with one or more systems or modules described herein.

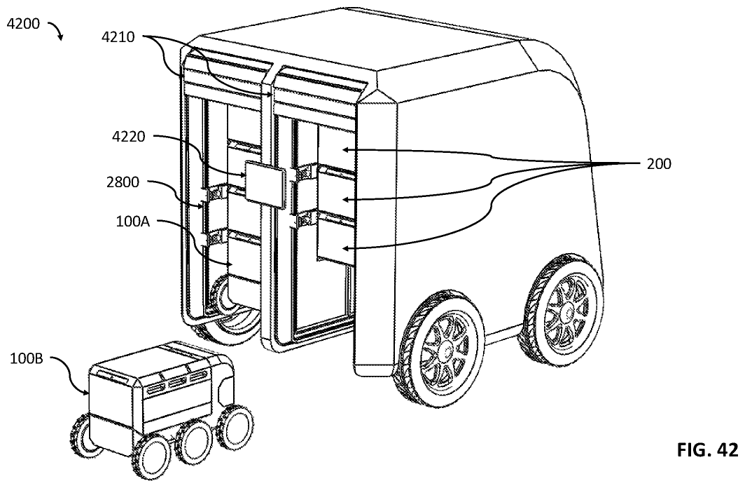

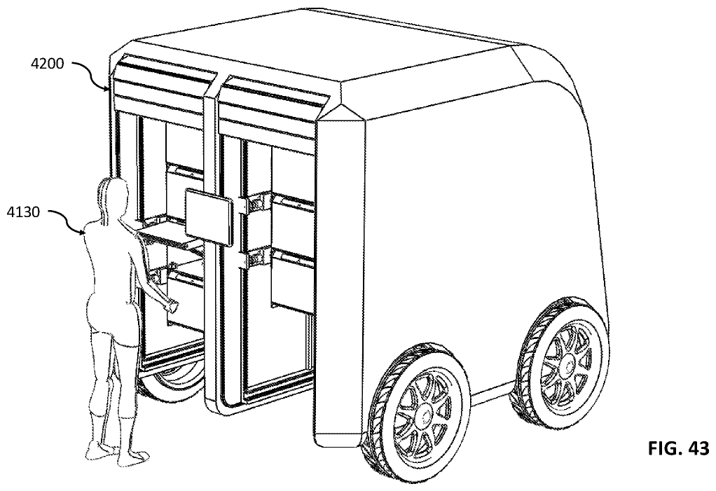

FIG. 42 illustrates an embodiment of a delivery cargo handling system 4200. As shown, two cargo handling modules 2800 and joined extension modules (not illustrated) store a number of modular cargo containers 200, and all are enclosed within the delivery cargo handling system 4200. Retractable doors 4210 enclose and secure the contents of the system 4200. The delivery cargo handling system 4200 is configured to autonomously travel and transport the contents to another destination, such as another warehouse facility or a neighborhood. Individual delivery devices 100A-B, which include a transportation platform 210 and the one or more docked modular cargo containers 200, are also transported within the delivery cargo handling system 4200. In one non-limiting example, the delivery cargo handling system 4200 travels to and parks in a specified location, for example, a neighborhood. The modular cargo containers 200 may include cargo that will be delivered to destinations around the neighborhood, such as for example, destinations within an about 5-mile radius of the parked delivery cargo handling system 4200. The retractable doors 4210 are opened. A delivery device 100B unparks from the cargo handling module 2800 and autonomously travels to a load/unload destination associated with the docked modular cargo container 200. At the destination, the modular cargo container 200 opens a selected door, and cargo is either loaded or unloaded as previously discussed. The delivery device 100B subsequently travels to another destination or returns to the delivery cargo handling system 4200. A user interface touchscreen 4220 is also included for human interaction, if required, and further illustrated in FIG. 43. Alternatively, such interaction may be done remotely as described elsewhere herein.

### Exemplary Methods of the Cargo Handling System

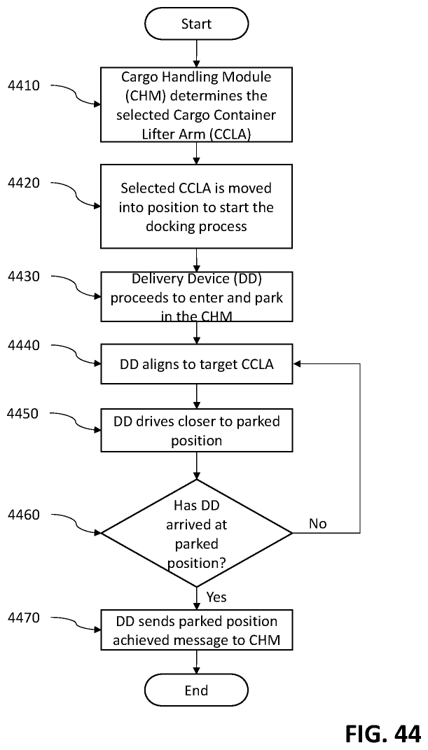

FIG. 44 is a flowchart diagramming one embodiment of a method to park a transportation platform 210 and undock a modular cargo container 200 in a cargo handling module 2800. At block 4410, the module microcomputer 2930 of the target cargo handling module 2800 determines and selects which attached arm 2820, 2830 to use to undock the modular cargo container 200. For example, if the cargo handling module 2800 is empty, the upper arm 2920 is selected, at block 4420, to lower in order to attach, undock, and lift the modular cargo container 200. If there is already one or more modular cargo containers 200 stored in the cargo handling module 2800, one of the lower arms 2830 is selected, at block 4420, to lower in order to attach, undock and lift the modular cargo container 200. More specifically, the upper arm 2920 and the lower arms 2930 are all lowered until the lower arm 2930 attaches to the top of the modular cargo container 200. Then all the arms 2920, 2930 are raised to elevate the attached modular cargo container 200 with the upper arm 2920. When one modular cargo container is attached to the upper arm 2920 and a second modular cargo container requires undocking, a second lower arm 2930 is selected. While the second lower arm 2930 is selected to engage and raise the second modular cargo container, any other lower arms 2930 are all lowered with the selected lower arm. At block 4430, the delivery device 100 enters the bottom area of the cargo handling module 2800, and, at block 4440, aligns itself to the selected arm 2820, 2830. The delivery device 100 continues to position itself closer at block 4450, until, at block 4460, it is determined that the delivery device 100 is properly parked. If the delivery device 100 is not aligned properly, the process returns to block 4440 for further refinement. At block 4470, the delivery device 100 sends a parked signal and optionally, identification data of the transportation platform and the docked modular cargo containers, to the module microcomputer 2930.

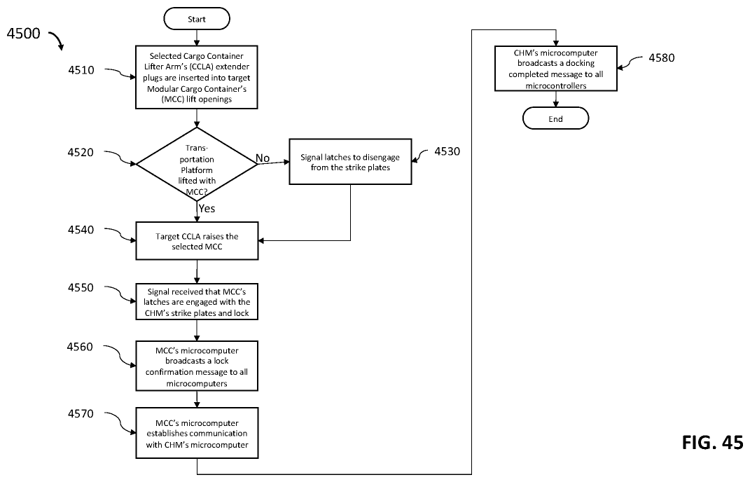

FIG. 45 is a flowchart diagramming one embodiment of a method to undock the modular cargo container 200 for storage in the cargo handling module 2800. At block 4510, if one of the lower arms is selected, the horizontal extenders 3300 (shown in FIG. 33) of the selected lowered arm 2830 are extended inward thereby inserting the plugs 3310 into the openings 760 of the modular cargo container 200. At block 4520, it is determined whether or not the transportation platform 210 is to be stored along with the modular cargo container 200. If not, the modular cargo container 200 is undocked from the transportation platform 210 by receiving a signal to disengage the latches from the strike plates, thereby allowing the modular cargo container 200 to be released. It will be appreciated that either the modular cargo container 200 or the transportation platform 210 may have the active latches. At block 4540, the lowered arms 2830 begin to raise either the released modular cargo container 200 or both the modular cargo container 200 and the transportation platform 210. When the modular cargo container 200 is raised to either another higher modular cargo container or the upper arm 2820, at block 4550, the microcomputer 1010 of the modular cargo container 200 receives a signal that the latches 640 on the top surface are engaged with the module connectors 430 on the bottom surface of a higher stored modular cargo container. In the event that the upper arms 2820 are selected to raise the modular cargo container 200, the upper and lower arms 2820, 2830 are lowered and the latches 640 engage with the module connectors 3100 of the cargo container attachment device 3010 attached to the upper arm 2920. The microcomputer 1010 broadcasts a locked confirmation message to all associated microcomputers (e.g., microcomputer 500, module microcomputer 2930) at block 4560. At block 4570, the microcomputer 1010 establishes communication with the module microcomputer 2930, and, at block 4580, the module microcomputer 2930 broadcasts a docking completed message to all associated microcomputers.

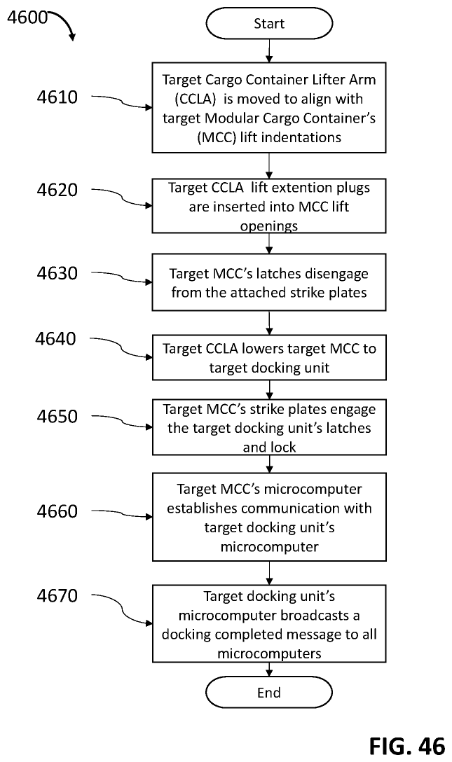

FIG. 46 is a flowchart diagramming one embodiment of a method to dock the modular cargo container 200 from storage in the cargo handling module 2800 onto either a transportation platform 210 or a shuttle 3830. In a non-limiting example, a stored modular cargo container is attached to either the bottom of another cargo container or the cargo container attachment device of the upper arm. The stored modular cargo container is docked onto a docking unit (e.g., either a transportation platform 210 or a shuttle 3830), at block 4610, by moving the selected lower arms 2830 to align the extender plugs 3310 with the lift openings 760, and, at block 4620, insert the plugs 3310 into the openings 760. At block 4630, a signal is transmitted to the latches 640 of the modular cargo container 200 to disengage from either module connectors 430 of the higher modular cargo container or the module connectors 3100 of the cargo container attachment device 3010. At block 4640, the selected arms 2830, lower the modular cargo container 200 to the docking. When docked, at block 4650, the latches 230 of the transportation platform 210 or the latches 3910 of the shuttle 3830 are engaged and locked. At block 4660, the microcomputer 1010 establishes communication with the microcomputer 500 or a microcomputer of the shuttle 3830. The docking unit's microcomputer then, at block 4670, broadcasts a docking complete message to all associated microcomputers.

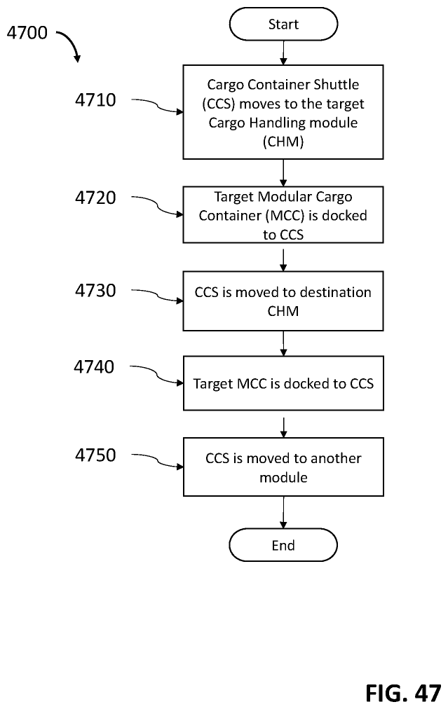

FIG. 47 is a flowchart diagramming one embodiment of a method to move a modular cargo container from one cargo handling module to another cargo handling module. At block 4710, the shuttle 3830 moves to the target cargo handling module, for example, module 2800, that is storing the modular cargo container 200. At block 4720, the modular cargo container 200 selected for moving is docked onto the shuttle 3830 as described in connection with FIG. 26. At block 4730, the shuttle moves from the first cargo handling module (e.g., module 2800) to a selected cargo handling module (e.g., extension module 3700A or 3700B). The modular cargo container 200 is undocked from the shuttle 3830 as described in connection with FIG. 25, at block 4740, and, at block 4750, the shuttle may travel to another module for further shuttling.

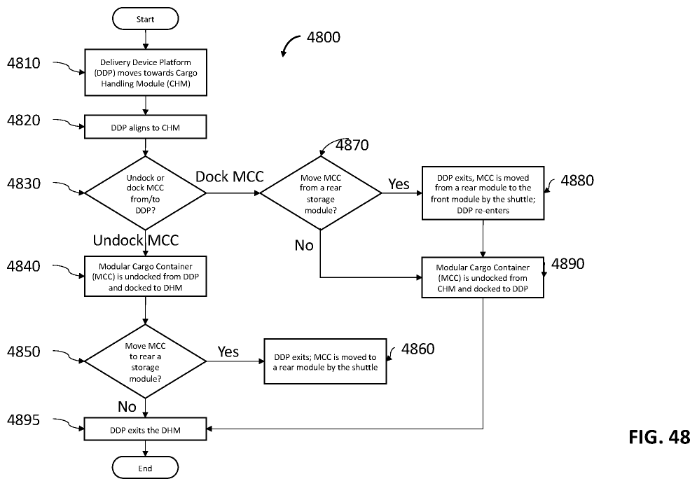

FIG. 48 is a flowchart diagramming one embodiment of a method to dock or undock a modular cargo container in the cargo handling system. At block 4810, a transportation platform 210 moves towards a cargo handling module 2800, and, at block 4820, aligns itself to the module 2800. It will be appreciated that the transportation platform may also be the shuttle 3830. At block 4830, the module microcomputer 2930 determines whether to dock or undock the modular cargo container 200. At block 4840, the modular cargo container 200 is undocked from the transportation platform and docked to the cargo handling module 2800. At block 4850, the module microcomputer 2930 determines that the undocked modular cargo container 200 should be moved to a rear storage module (e.g., 3700A-B), and, at block 4860, the transportation platform 210 exits the cargo handling module 2800, and the shuttle 3830 enters the module 2800 to move it to one of the rear modules, as described in connection with FIG. 47. If, at block 4830, the modular cargo container 200 requires docking, the module microcomputer 2930, at block 4870, determines in which module (e.g., 2800, 3700A-B) the modular cargo container is stored. If it is determined that the modular cargo container 200 needs to be moved from a rear module 3700A-B to the front module 2800, at block 4880, the transportation platform 210 exits the cargo handling module 2800, and the shuttle 3830 moves the cargo container 200 from a rear module to the front module 2800, as described in connection with FIG. 47. The transportation platform 210 re-enters the front module 2800, and, at block 4890, the modular cargo container 200 is undocked from the module 2800 and docked onto the transportation platform 4890. The transportation platform 210 then exits the module 2800 at block 4895.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor on the microcomputers and/or computing devices. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

As used in the description and claims, the singular form “a”, “an” and “the” include both singular and plural references unless the context clearly dictates otherwise. For example, the term “number” may include, and is contemplated to include, one or more, a subset of, or a plurality of modular cargo containers. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An autonomous delivery device for loading, transporting and unloading cargo, the delivery device comprising:
a first modular cargo container for enclosing cargo, the modular cargo container defining a container interior for enclosing cargo therein and comprising:
a rear door that has an open and a closed position allowing access to the container interior while loading and unloading the cargo,
a bottom connector for transferring and receiving power and data, and
a plurality of module connectors located on a bottom surface of the first modular cargo container; and
a transportation platform having a plurality of wheels for transporting the first modular cargo container from an origin to a first destination, the transportation platform comprising:
a cargo receiving area connector for coupling to the bottom connector of the first modular cargo container for transferring and receiving power and data therebetween,
a plurality of transportation platform active latches for locking and unlocking the plurality of module connectors of the first modular cargo container,
a power system for powering at least one of the transportation platform and the modular cargo container, and
a transportation microcomputer to operate the transportation platform,
wherein cargo is loaded into the container interior through the rear door in the open position, and the transportation microcomputer transmits a closed position electrical signal via the cargo receiving area connector of the transportation platform and the bottom connector of the first modular cargo container to position the rear door to the closed position;
wherein the transportation microcomputer is configured to receive delivery instructions and activate the transportation platform to autonomously move towards the first destination; and
upon arriving at the first destination, the transportation microcomputer transmits an open position electrical signal to position the rear door in the open position, such that the cargo is configured to be unloaded at the first destination.

2. The autonomous delivery device of claim 1, further comprising a second modular cargo container positioned on an upper surface of the first modular cargo container for delivering a second cargo to one of the first or a second destination, wherein the second modular cargo container defines a second container interior and comprises:
a second rear door that has a second open and a second closed position allowing access to the second container body while loading and unloading the second cargo;
a second bottom connector configured to connect to an upper connector of the first modular cargo container for transferring and receiving power and data; and
a second plurality of module connectors located on a second bottom surface of the second modular cargo container,
wherein the second plurality of module connectors of the second modular cargo container is configured to lock to a plurality of latches on the upper surface of the first modular cargo container.

3. The autonomous delivery device of claim 2, wherein the second cargo is loaded into the second container body through the second rear door in the second open position, and
wherein the transportation microcomputer transmits a closed position electrical signal to the second modular cargo container via the cargo receiving area connector of the transportation platform, the bottom and upper connectors of the first modular cargo container, and the second bottom connector of the second modular cargo container to position the second rear door to the second closed position.

4. The autonomous delivery device of claim 2, wherein the transportation microcomputer is configured to receive delivery instructions for the second cargo and activate the transportation platform to autonomously move towards one of the first and second destinations; and
wherein, upon arriving at one of the first or second destinations, the transportation microcomputer transmits an opened position electrical signal to position the second rear door to the second open position, and unload the second cargo.

5. The autonomous delivery device of claim 1, wherein the first modular cargo container further comprises a conveyor belt and a conveyor actuation module for moving the conveyor belt in a first and a second direction within the first container interior,
wherein the cargo is loaded into the first container interior by positioning the cargo on the conveyor belt moving in the first direction, and the cargo is unloaded from the first container interior by moving the conveyor belt in the second direction.

6. The autonomous delivery device of claim 1, wherein the first modular cargo container further comprises a disinfecting module positioned within the first modular cargo container for disinfecting at least a portion of the enclosed cargo.

7. The autonomous delivery device of claim 1, wherein the first modular cargo container further comprises a cargo container microcomputer for transmitting and receiving data and processing commands.

8. The autonomous delivery device of claim 7, wherein the cargo container microcomputer is configured to transmit an electrical signal to one or more actuators coupled to the rear door for moving the rear door between the open and closed positioned,

9. The autonomous delivery device of claim 8, wherein the cargo container microcomputer is configured to transmit a rear door status to the transportation microcomputer.

10. The autonomous delivery device of claim 7, wherein the cargo container microcomputer is configured to receive and process sensor data from one or more sensors positioned in or on the first modular cargo container.

11. The autonomous delivery device of claim 10, wherein the one or more sensors comprise one or more of: a camera sensor; a temperature sensor; a humidity sensor, a proximity sensor, a pressure sensor, a level sensor, a gas sensor, an infrared sensor, or equivalents thereof.

12. The autonomous delivery device of claim 1, wherein the bottom surface of the first modular cargo container and the upper surface of the transportation platform each further comprise complementary docking surfaces for aligning and docking the first modular cargo container on the transportation platform.

13. The autonomous delivery device of claim 12, wherein the first modular cargo container is aligned and docked to the transportation platform by one of: manually or automatically by a cargo handling system.

14. A method for autonomously loading, transporting, and unloading cargo, the method being performed by an autonomous delivery device and comprising:
at a first modular cargo container:
receiving a first cargo, and
docking to a transportation platform;
at the transportation platform:
receiving a delivery destination for the first cargo,
autonomously transporting the first modular cargo container to the delivery destination, and
upon arriving at the delivery destination, transmitting an arrival signal to the first modular cargo container;
at the first modular cargo container:
receiving the arrival signal,
transmitting an open signal to open a rear door,
transmitting an unload signal to activate a conveyor belt in an unload direction to unload the first cargo,
upon sensing that the first cargo was unloaded, deactivating the conveyor belt,
transmitting a close signal to close the rear door, and
transmitting a door status signal to the transportation platform; and
at the transportation platform:
receiving the door status signal, and
transporting the first modular cargo container to another location.

15. The method of claim 14, further comprising, at the first modular cargo container:
activating the conveyor belt in a load direction to load the first cargo;
sensing the loaded first cargo; and
deactivating the conveyor belt.

16. The method of claim 15, further comprising:
at a second modular cargo container docked to a top surface of the first modular cargo container docked to the transportation platform:
receiving a second cargo;
at the transportation platform:
autonomously transporting the first and second modular cargo containers to the second delivery destination, and
upon arriving at the second delivery destination, transmitting a second arrival signal to the second modular cargo container;
at the second modular cargo container:
receiving the second arrival signal,
transmitting an open signal to open a second rear door,
activating a second conveyor belt in an unload direction to unload the second cargo,
upon sensing that the second cargo was unloaded, deactivating the second conveyor belt,
transmitting a close signal to close the second rear door, and
transmitting a second door status signal to the transportation platform; and
at the transportation platform:
receiving the second door status signal, and
transporting the first and second modular cargo containers to one of the first delivery destination or another location.

17. The method of claim 14, further comprising, at the first modular cargo container, activating a disinfecting module positioned within the first modular cargo container and disinfecting at least a portion of the first cargo.

18. The method of claim 17, further comprising receiving and processing sensor data at a cargo container microcomputer, wherein the sensor data is received from a plurality of sensors positioned in or on the first modular cargo container.

19. The method of claim 18, wherein the sensors comprise one or more of: a camera sensor; a temperature sensor; a humidity sensor, a proximity sensor, a pressure sensor, a level sensor, a gas sensor, an infrared sensor, or equivalents thereof.

20. The method of claim 16, further comprising:
aligning and docking, via complementary docking surfaces, the first modular cargo container on the transportation platform; and
aligning and docking, via second complementary docking surfaces, the second modular cargo container on the first modular cargo container.
